(19) United States
(12) Patent Application Publication
(10) Pub. No.: US 2024/0235847 A1
(43) Pub. Date: Jul. 11, 2024

(54) SYSTEMS AND METHODS EMPLOYING SCENE EMBEDDED MARKERS FOR VERIFYING MEDIA

(71) Applicant: John Elijah Jacobson, San Francisco, CA (US)

(72) Inventor: John Elijah Jacobson, San Francisco, CA (US)

(21) Appl. No.: 18/290,677

(22) PCT Filed: Jul. 22, 2022
(86) PCT No.: PCT/US2022/038080

§ 371 Date: Jan. 19, 2024

Related U.S. Application Data
(60) Provisional application No. 63/346,901, filed on May 29, 2022.
(60) Provisional application No. 63/224,412, filed on Jul. 22, 2021.

(51) Int. Cl. H04L 9/32; G06T 1/00; G06V 20/40; G10L 19/018; G10L 25/57

(52) U.S. Cl. CPC H04L 9/3247; G06T 1/0085; G06V 20/44; G10L 19/018; G10L 25/57; G06V 2201/10

(57) ABSTRACT

Display badges employing scene embedded digital watermarks for authenticating media data typically comprising: an audio detection component detecting at least a portion of ambient audio data of an actual event; a computing device operably connected to a recording component; the computing device converting at least a portion of the detected ambient audio data into a digital representation of the at least a portion of the ambient audio data; a display presenting a succession of images comprising the digital representation; where the display badges are designed such that the digital representation is sufficiently visible that it may be extracted by a computer upon replay of audio and video of some or all of the actual event, and the replay audio may be verified as authentic by comparing the digital representation with the audio associated with the replay. Methods for encoding and authenticating media data are also disclosed.

### CROSS REFERENCE TO RELATED APPLICATIONS

This application claims priority pursuant to 35 U.S.C. § 119(e) to U.S. Provisional Application Nos. 63/224,412, filed Jul. 22, 2021, and 63/346,901 filed May 29, 2022, which are incorporated herein by reference in there entireties.

### FIELD OF THE INVENTION

This application relates to the field of media verification utilizing embedded markers. Specifically, embodiments of the present invention provide systems and methods for employing scene embedded digital markers for determining the veracity of media files, thereby protecting society from fake media that purports to be truthful representations of actual occurrences.

### DISCUSSION OF THE BACKGROUND

Currently available video technologies such as deepfake (alternatively deep-fake, deep fake) enable users to generate prima facie believable fake video purporting to portray videos or images that are real, but in actuality, did not occur. Proposed solutions in the art include improving digital video forensic analyses, electronically inserting watermarks into recorded video via camera hardware or camera apps, or electronically inserting time stamps and/or storing videos or hashes of video files on cloud servers along with blockchain timestamps.

Digital forensic techniques may analyze videos for inconsistencies in facial expressions or detect real faces that may expose a deepfake video, but such techniques are readily becoming obsolete as deepfake technology develops more realistic images and videos.

Electronically inserted watermarks (EIWs) attempt to authenticate images by digitally signing the media that hardware records. Software may also provide EIWs through applications. EIWs, however, are replete with issues.

First, EIWs do not address devices currently on the market that lack EIW technology or prevent malicious actors from developing their own fraudulent EIW software. Second, since the EIWs are in the capturing software or hardware in cameras, the camera owners have authority over which images are taken or disseminated, not the image subject. Subjects of captured media could be victims of individuals without trustworthy EIWs or without EIWs at all. Finally, EIWs, at best, certify the device used to capture media did not use deepfake technology, but it does not certify the veracity of a captured scene. Thus, an individual may capture a screen showing a deepfake video but a camera with an EIW would still certify the captured content as authentic.

Near immediate cloud storage of media attempts to solve this problem but fails for the same reasons that EIW do. Immediate cloud storage of media has special camera and apps to authenticate what it captures. However, like hardware with EIW technology, the technology merely authenticates the device but does not certify the veracity of the captured scene.

An individual may attempt to authenticate his own identity by recording on his own personal device. However, this does not address the problem with others recording the individual, applying deepfake technology to the captured media, and then passing off the doctored media as authentic.

Given the increasing availability and ease of use of AI deepfake creation tools, such as FakeApp, deepfake technologies could increasingly undermine trust in video and images. The existence of deepfake technologies distort perceptions of reality, unjustly harm (or help) political candidates, ruin reputations, fabricate provocative events, and skew jurists' view of video evidence. Given the ways deepfake technology erode valuable social trust, and the cost of such erosions, it is urgent to find ways to eliminate the threat from deepfake technology. The present invention overcomes the problems of identifying deepfakes and allows subjects vulnerable to deepfakes to defend themselves with the apparatus and methods comprising the invention.

### SUMMARY OF THE INVENTION

The present invention advantageously provides systems and methods for employing Scene Embedded Digital Watermarks (SEDW) to test the veracity of media files and protect society from fake media purported to be truthful representations of actual occurrences. The system comprises cloud services, decoder apps and, most importantly, a novel class of scene embedded devices which display, among other things, digital signatures recapitulating contemporaneous physical properties of a scene, so that if the display is recorded, for example, in a video along with the rest of the scene, video of the embedded display can validate the veracity of other aspects of the scene.

SEDW devices have numerous applications, but generally allow individuals to broadcast on the SEDW displays Coded Scene Values (CSVs), which comprise encrypted, signed or re-displayed data derived from, among other things, (i) sensors monitoring physical properties of the scene, such as audio, brightness, acceleration forces etc., (ii) global data such time, geo-positioning, etc., (iii) specific incoming data from, for example, WIFI®, and (iv) device user identity. Videographic and other scene recordings capture these SEDW device displays re-broadcasting cryptographically signed and encrypted valid scene information. SEDW data can then be compared with other alleged scene data to validate the veracity of the other alleged scene data.

In a typical application, a public speaker may wear an SEDW device with a badge sized display screen on his lapel (see e.g., FIG. 1, further described below). Video of the scene captures the speaker and the SEDW badge device's display. The badge display presents audio information and a digitally signed canonical audio recording of the speaker. Thus, videography recording the speech captures the badge display along with the speaker's video and audio. Since the badge displays a secure unique animation of digital signatures validating overlapping audio snippets composing the entire speech, dubbing and other misleading alterations are foiled, because the badge display would expose a difference between the dubbed audio and the actual audio information re-transmitted on the badge display. Encryption properties of the SEDW devices and systems also foil splicing, re-ordering, and deepfakes generally, because the SEDW devices displays in the scene not just the audio, but also, for example, the order, the timing, the session, the speaker's ID, the device ID, and secure links to additional information in the cloud.

The component of the SEDW device transmitting CSVs is called the device's display whether it is an OLED screen, a set of lights, a set of speakers, or other signal output generator. SEDW devices may also have multiple displays. The transmitted CSVs typically contain digitally signed scene information certifying the veracity of the recorded scene, such that splices, temporal re-orderings, dubbings, inserted virtual objects, photoshopping and other alterations may be detected by a decoder processing the scene and the transmuted CSVs. To decode, the decoder applications ordinarily will access public keys registered to devices and device owners stored in the cloud.

Thus, the present invention offers novel solutions for combating a specific problem of audio-video distorting deepfakes. However, the technology may be generalized for policing the veracity of recorded media depictions of scenes by comparing a SEDW device's display information embedded in a scene with purported images of the scene.

### BRIEF DESCRIPTION OF THE DRAWINGS

FIG. 1 is a diagrammatic representation of a SEDW according to an embodiment of the invention.

FIG. 2A is a flow diagram for a method of encoding a SEDW according to an embodiment of the invention.

FIG. 2B is a flow diagram for a method of decoding a SEDW watermark according to an embodiment of the invention.

FIG. 3 shows a display badge according to an embodiment of the invention.

FIG. 4A is a diagrammatic representation of a method for encoding a SEDW in a display badge according to an embodiment of the invention.

FIG. 4B is a diagrammatic representation of a method for decoding a SEDW from a display badge according to an embodiment of the invention.

FIG. 5A is a flow diagram for a method of encrypting a hash of scene information using a private key according to an embodiment of the invention.

FIG. 5B is a flow diagram for a method of decrypting a hash of scene information using a public key according to an embodiment of the invention.

FIG. 6 is a flow diagram for a method by which a user may authenticate a video according to an embodiment of the invention.

FIG. 7 is a diagrammatic representation showing the application of SEDWs to remote inspection of buildings.

FIG. 8 is a diagrammatic representation showing the application of SEDWs to vehicles.

FIG. 9 is a diagrammatic representation showing the application of SEDWs to location verification.

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it should be understood that they are not intended to limit the invention to these embodiments. On the contrary, the invention is intended to cover alternatives, modifications, and equivalents that may be included within the spirit and scope of the invention as defined by the appended claims. Furthermore, in the following detailed description of the present invention, numerous specific details are set forth in order to provide a thorough understanding of the present invention. However, it will readily be apparent to one skilled in the art that the present invention may be practiced without these specific details

As used herein, a “scene” is a localized spatial-temporal physical happening, for example, a speech, a bar fight, a car cutting off another on a freeway, or a police shooting.

As used herein, “recorded media” is paradigmatically video-audio recordings of a scene, but may be generalize to include all recordable measurements of and within a scene (e.g., a lidar profile, accelerometer measurements, time signals (from clocks or GPS), accelerometer values of tagged scene objects, etc.).

As used herein, “image” is used to describe what recorded media captures, regardless of whether the recorded media captures a picture. “Images” may, in specific examples, refer to visual pictures, but when generalizing, the term may be used as it is used in the fields of signals processing and computer science to designate any sufficiently complex recorded aspects of a scene, such as audio or accelerometer data. An image in this sense is data isomorphic to what it represents.

As used herein, “veridical” when referring to recorded media means when the recorded media accurately represent the portrayed scene.

As used herein, “veracity” is distinct from “certified” or “authenticated” in that the later terms depend on the imprimatur of an authority, while “veracity” depends on the relationship to reality. Veracity means true. Certified or authenticated are only, at best, somehow notarized.

As used herein, “display” as in a SEDW device may be a screen (e.g., as part of a smartwatch, smartphone, mobile device, etc.), or may be specialized SEDW device hardware. “Display” is also used to denote an outbound signal from an SEDW device intended to be recorded upon recorded media capturing a scene. So, an audio speaker, strobe lights, LEDs, electromagnetic broadcasts, vibrations, anything which displays information intended for recording media capture on an SEDW device constitutes a display signal. Signaling such as wireless pairing to a mobile device to upload data or manage cloud services are not part of the display. There can be instances where the same physical output mechanism can sometimes act as a display of near-contemporaneous scene information or the physical mechanism for data management.

In their simplest form, embodiments of the present invention advantageously provide systems and methods for encoding a SEDW with audio data and metadata from an actual scene or occurrence, decoding such SEDWs, and verifying media data by comparing the media data with the decoded audio data and metadata.

Throughout this application, including the drawing figures, SEDWs (e.g., a display badge) may be referred to as a “TrueBadge.”

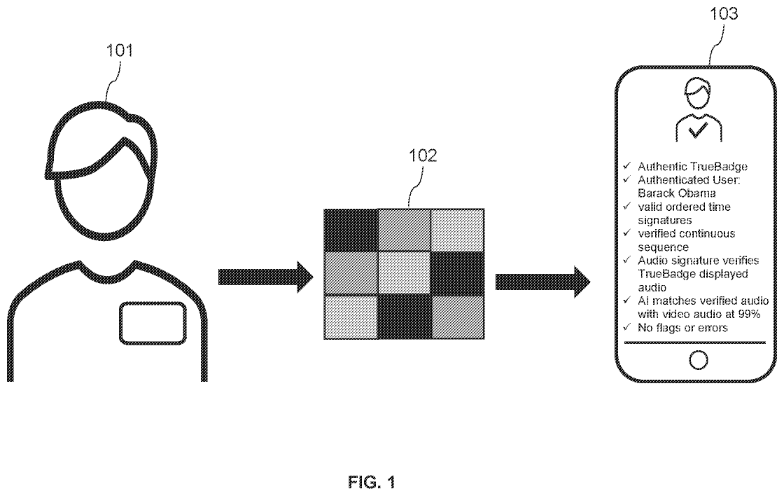

FIG. 1 shows a graphical representation of a user wearing a SEDW (in the form of a display badge) 101, which displays encoded images 102, and authenticates a variety of aspects of a recorded video of the user (e.g., the badge itself, the user, time signatures, sequences, displayed audio, audio in the video, etc.), flags errors, and displays, for example, on a mobile device 103, the results of the authentication.

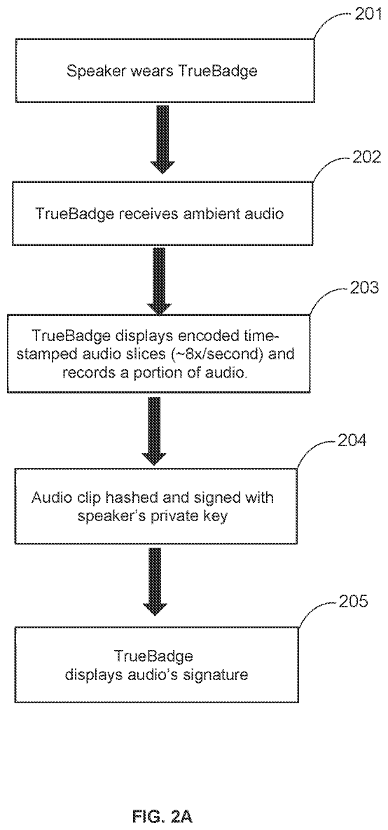

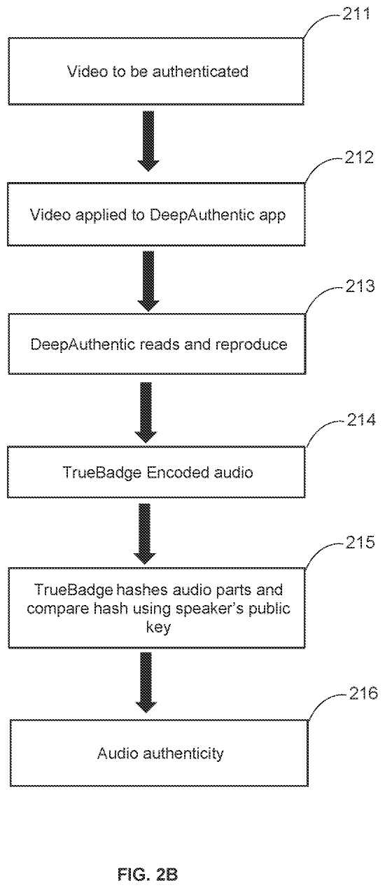

In FIG. 2A is shown a flow chart of a typical method for encoding a SEDW. At 201, a user (for example a person speaking publicly) wears a SEDW in the form of a TrueBadge. At 202, the TrueBadge receives ambient audio. At 203, the TrueBadge displays encoded, time-stamped audio slices, and records at least a portion of the audio. At 204, the at least a portion of the audio is hashed and signed with the speaker's private key. At 205, the TrueBadge displays the audio's signature.

FIG. 2B is a flow chart of a typical method for decoding a SEDW. At 211, video to be authenticated is captured and at 212, is applied (e.g., uploaded) to a DeepAuthentic application (described in more detail below). At 213, the DeepAuthentic application reads and reproduces at least a portion of the audio from the video to be authenticated. At 214, the DeepAuthentic applications retrieves the TrueBadge encoded audio, and at 215 hashes the at least a portion of the audio from the video to be authenticated, decodes the TrueBadge encoded audio using a public key, and compares the hashed portion to the decoded audio to determine if the video is authentic. At 216, the authenticity of the video is displayed.

It should be noted that there is an important distinction between inserted versus embedded watermarks. Inserted watermarks are added by the machinery recording a physical property of the world, or other machinery subsequently processing the recording. They ordinarily use the cryptographic techniques of digital signatures which through hashing can verify with arbitrary precision every aspect of the image, and through cryptography control what is signed and what is decodable. In contrast, embedded watermarks are in the world, like a clock tower in a photograph. They are not added to a captured image but are part of the world scene the recording media captures. Until this invention, embedded watermarks, such as clock towers were unable to digitally authenticate an entire image with the mathematical power of a digital signature, because (i) what was below a clock tower could be photoshopped, or (ii) a clock tower itself could be photoshopped.

The present invention relates to a new kind of watermark with the advantages of scene embedding and the cryptographic advantages of inserted digital signatures.

Again, to summarize this critical contrast between the state of the art and the present invention; Electronically inserted watermarks (EIWs) modulate or append electronic representations of a scene arising after processing through a microphone or charge-coupled device (CCD) or similar sensor. A SEDW is in the world—in the scene captured and recorded by sensors (such as CCDs). In the case of a visual image, SEDWs pass with other light from the real-world scene into a camera's aperture onto sensors transducing light into electric current. In contrast, EIWs emerge from within a camera's image processing engine to change electronic representations within the camera or in subsequent processing. EIWs transform the captured electronic image. SEDWs enter the aperture or sensor from the world scene.

EIWs alter a representation of the world while SEDWs are in the world and thus captured within faithful representations of the world. The ordinary passport inserts a watermark onto a representation, a photo, while the face tattoo embeds a watermark into a scene. This move from inserting authenticating representations in media toward embedding authenticating marks within the scene is a critical move and when taking full advantage of the features of digital signatures offers a novel and useful solution to the fake media problem.

It is easiest to describe a simple, novel, concrete version of the invention in action from the standpoint of a hypothetical user, and then further describe its generalization, variations, alternative embodiments, and deployments in other contexts.

### Example Embodiment—Sen. Alex Smith's “TrueBadge”

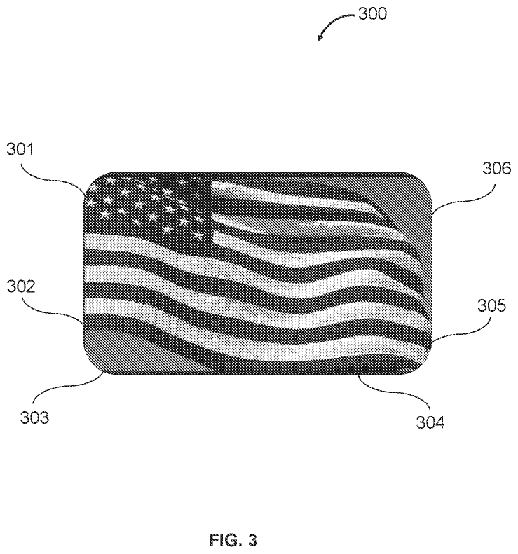

An individual, Sen. Alex Smith, fears being a victim of a deepfake. He could purchase the main component of this invention, a TrueBadge (see e.g., FIG. 3, described in more detail below). A TrueBadge may comprise a mobile computer (a processor) with a display and an audio detection component (e.g., a microphone). The TrueBadge may be designed to be worn on a lapel or like a broach. It may be instantiated in a smart watch running the TrueBadge application and attached to the wearer with a TrueBadge clip (or lanyard or other means). To initialize the TrueBadge software, a cloud-based registration and credentialing procedure links the Senator's identity with the TrueBadge, offers information management services, and generates one or more public/private key pairs for the Senator and his device. Details on the cloud components of this invention are discussed in further detail below.

Before a speech or at other times if the Senator wishes to protect himself from deepfakes, he could securely activate his TrueBadge (via password, biometric ID etc.) In a typical scenario, the TrueBadge may use the audio from the Senator's speech to modulate an animation displayed on the TrueBadge. For example the TrueBadge may display animated Quick Response two-dimensional bar codes (QR codes) to encode and re-broadcast via the display (i) the audio of his speech digitally-signed with the Senator's ID and device ID credentials via private key(s), (ii) encrypted the start time, elapsed time, order labeled snippets of his speech and hash type, (iii) an encrypted Session ID, (iv) unencrypted forward error correcting codes, and (v) encrypted and unencrypted but mostly signed meta-data. The animated QR code or animated encoding image could run, for example, at six or eight frames per second with each frame displaying temporally overlapping audio information. Temporal overlap foils malicious frame re-ordering and can buffer against interruptions in the viewing of the display. (e.g., if frames on the display are missing, overlapping data will provide redundancy. A six frames per second rate could be sampled from standard 24 and 30 frame per second video recorders. Higher rates of course can carry more data.)

Recorded video of Sen. Alex Smith speech could include the protective, embedded TrueBadge display on his lapel. Unlike problematic proposed solutions, anyone with the appropriate publicly available decoder could objectively check the veracity of the video, since the decoder can extract all the speech audio encoded in the TrueBadge display frames along with ordering, session time, elapsed time information, identification and authenticating signatures. TrueBadge may include a SEDW device that allows anyone in the world to inspect and verify the veracity of the scene the recorded media purports to show. Because anyone can do it and the check does not require mediation through a human authority; it is ultimately democratic and objective.

In the event the lapel worn TrueBadge is not captured on camera, the TrueBadge offers a variety of back-up protections. Back-up protections may include saving a signed canonical recording, uploading live environment stamped recordings, contemporaneous radio broadcasting of the information in the visual display, dynamic illumination of the Senator or his background, and other protections.

A viewer watching a video recording of Senator Alex could authenticate the recording using a decoder. The decoder is device or program, a component of this invention, that may extract data from the TrueBadge, the video and the internet. After extracting data, the decoder may flag content using deepfake technology and offer additional data on the scene. Decoders may identify a doctored video, because the dubbed video would not match the canonical sound file displayed on the TrueBadge.

If an individual attempts to doctor the video recordings of Senator Alex, the TrueBadge would not verify the authenticity of the doctored media. Spliced or reordered video snippets could not be authenticated by the session ID, start and elapsed time information, and display frames with overlapping audio information. Also, the TrueBadge could not be photoshopped into media because: (i) the media would trigger multiple alarms, and (ii) private key encryption would prevent improperly credentialed TrueBadges from appearing legitimate, since they would specifically lack valid registration and appropriate ID codes. The TrueBadge makes cobbling snippets from various appearances impossible, because sessions, times, audio etc. would not match. It can make it impossible for the Senator to repudiate recorded media with a verified TrueBadge SEDW. TrueBadges may create norms such that recorded media missing a TrueBadge and purporting to come from the Senator would be dismissed, as video of an individual in full visual and audio disguise purporting to be the Senator would be dismissed.

Finally, because TrueBadges are password locked and could contain smart phone security features (memory wiping after multiple biometric/password failures, remote wiping etc.), stealing the Senator's TrueBadge would be at least as hard as stealing a phone and hacking into it-likely more difficult since TrueBadge software and systems are not as open to apps and malware as fully functional smartphones.

The TrueBadge is a specially designed embedded watermark, specifically, a SEDW with the full cryptographic power of EIWs, except without the disabling disadvantages. SEDWs verify recorded media scenes, while EIWs only certify media. The SEDW device of the present invention may be further elaborated with flexible sensor suites, multifarious display types, cloud connectivity options, variegated form factors, user options, and more elaborations. These advantages together with the devastating disadvantages of EIWs make SEDW devices far superior to EIWs.

The TrueBadge display uses a private key to uniquely display ID information and this information can be checked using the decoder and a public key. Thus, since only TrueBadges can display valid TrueBadge ID (including serial information), they cannot be spoofed (e.g. maliciously inserted into a video).

There are at least three digital chains of custody: (i) the canonical media files recorded by the TrueBadge, (ii) the recorded media captured by third party recording devices, and (iii) public keys. The TrueBadge displays the canonical audio which can be read from the TrueBadge with the decoder software and public keys. Fakes are easily identified and there is no dependence on a human authority to hold the canonical recorded media file. Furthermore, registration of TrueBadges linking personal identity with a device's serial number further defend against schemes for illicit postings of fake identity and public keys pairs.

SEDWs apply digital signature and encryption technologies to physical scene attributes. A high-fidelity hash and cryptographic signature on the canonical audio file may make dubbing any part computationally infeasible. Session and time-stamped frames with overlapping audio information may expose edits, such as deletions, insertions, splices and re-orderings.

If the Senator publishes his public key, and system settings require public key publication or cloud services note public key publication, it will not be possible for the Senator to repudiate what he says, nor for others to accuse him of doctoring or repudiating his own words.

Since the TrueBadge is embedded in the world scene, videos taken with sufficiently high-fidelity images of the Senator and TrueBadge can be decoded to show the Senator said what the TrueBadge records and/or displays. DeepFakes that attempt to dub sounds, spoof identities, splice and/or edit a video will be easily identified by widely available and openly analyzable decoders.

Desiderata 1-4, common in digital signatures, show that the TrueBadge offers the cryptographic powers of conventional inserted signatures. Yet, because it is embedded in the world scene, the TrueBadge provides the Senator with protection against non-veridical videos—a feature connecting a digital representation to the world.

The TrueBadge ends the digital forensic cat and mouse game because it is not a digital forensic method. It is a method for embedding digital signatures with the strength of the best cryptographic methods-cryptographic methods which, barring new, alarming mathematics (e.g., showing P=NP in the PNP problem) are secure, tested and not in an unwinnable cat and mouse game.

TrueBadges can include the security features of modern cellphones and smartwatches and more-they can be remotely disabled, locked, located by GPS, send alarms of displaced, deregistered via associated cloud services (should remote disabling be blocked by radio barriers) and require passwords to initiate sessions.

Additionally, SEDWs such as TrueBadges work where friendly camera support is unavailable, for example to protect drivers, victims of police misconduct, and individuals in crowds, people in spatial zones too cramped to get friendly camera imagery, and intimate or private situations where even very friendly cameras would be unwelcome.

While, a “DeepAuthentic” cloud system is described below, the cloud system is not necessary for independent TrueBadge users and verifiers.

For example, the Senator could use the TrueBadge to display encrypted, signed audio and post the public keys anywhere without any cloud or blockchain service, even DeepAuthentic's cloud system. This carries some inconvenience to the user; for example the real ID of the TrueBadge user would not be registered, but the speech would be linked to a unique TrueBadge serial number and a public key, which would uniquely unscramble the TrueBadge Display. Thus, the Senator could opt to buy, but not register the TrueBadge, set the badge to display signed audio and related encrypted meta-data including the device serial number, but post the decoding public key(s) anywhere or withhold them. Only specific public keys will unscramble the TrueBadge display into anything remotely meaningful.

Accordingly, the Senator does not need DeepAuthentic cloud services or any other cloud service. The Senator may disseminate the public key online, in any media, or even during a video recorded speech. Then, any party with an authentic public key could decode the video. Others could not fabricate the public key or the device since it would not decode the TrueBadge displayed information. An open source decoder (including an open TrueBadge display codec) would relieve interrogators from trusting the decoding software.

Importantly, the powerful epistemic hack, which allows a TrueBadge user and video interrogator to dispense with purported cloud authorities, confers DeepAuthentic's system special authority. Suspicious interrogators can independently audit the most critical information on the DeepAuthentic cloud, in this case veracity of a video with a TrueBadge, without having to invest special trust in the information on DeepAuthentic clouds. Since the Senator's public key(s) and the TrueBadge cannot be spoofed, the public key(s) on the DeepAuthentic cloud will verify recorded media of a scene with a TrueBadge display or not.

Some further advantages of TrueBadges include: 1) TrueBadges are convenient, easily worn, inexpensive, 2) TrueBadges further express that the wearer is interested in truth, and interested in participating in a healthy epistemic community, and conversely arouse suspicion against public figures who do not use them, 3) TrueBadges allow anyone with access to inexpensive computers and public keys to verify videos, 4) TrueBadges allow contemporaneous functional testing (that, is one could point a decoder app equipped camera at, for instance, the Senator, and verify on scene that the TrueBadge is functioning, 5) TrueBadges transfer control to the would-be target of a deepfake, allowing self-reliant, confident protection, 6) the TrueBadge's encryption, decryption, signature and sensor compression technologies are well tested, public domain, off-the-shelf, algorithms, 7) TrueBadges constitute a public good restoring trust and accuracy to a domain in what was thought to be an incorrigibly dystopian, “post-truth” epistemic environment.

This technical description describes how the TrueBadge works and SEDW device systems work. The critical feature of SEDW devices is that they are embedded in scenes and display/broadcast information about the scene; e.g. sound, light properties, velocity changes etc.

The DeepAuthentic System may comprise a SEDW device, a decoder and cloud services. DeepAuthentic Cloud services are especially designed to work with DeepAuthentic products, but to maintain a deepfake solution that does not rely on a central authority. SEDWs are designed to allow anyone, including certificate authorities, to run their own cloud services. SEDWs may also function without cloud service at all and with little loss of function. Roughly, the SEDW records and displays an animation containing digitally signed information about its embedded physical scene. The decoder applications extracts, authenticates SEDW devices' scene information and applies the authenticated information to it to verify the veridicality of media purporting to accurately capture the scene. Cloud services manage and post data from SEDWs on registered user information pages. Cloud services also authenticate real users, post their public keys, and hold media data. Media data may include bandwidth limitations that prevent SEDW devices from displaying high-fidelity sound files. However, cloud stored media files are not required to authenticate and certify the veridicality of suspect media. Humans and decoder applications can access DeepAuthentic Cloud services.

Referring to FIG. 3 therein is shown an embodiment of a TrueBadge 300 comprising a microphone 301, optional backlights 302, a USB charging port and data port 303, a power switch 304, three optional backlights 305 and removable clip 306. As depicted, the TrueBadge uses an animated flag template, but this could be any of numerous modulated images, such as an animated two-dimensional QR code.

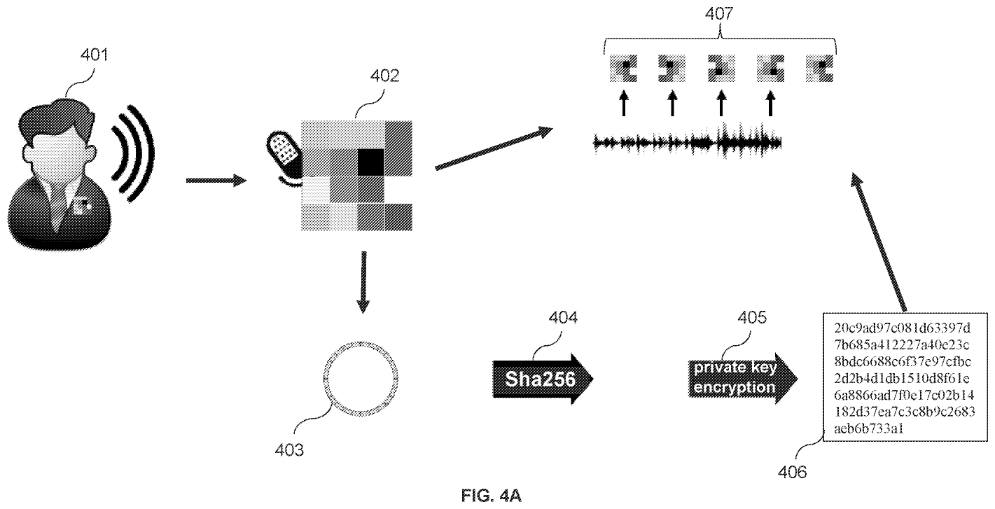

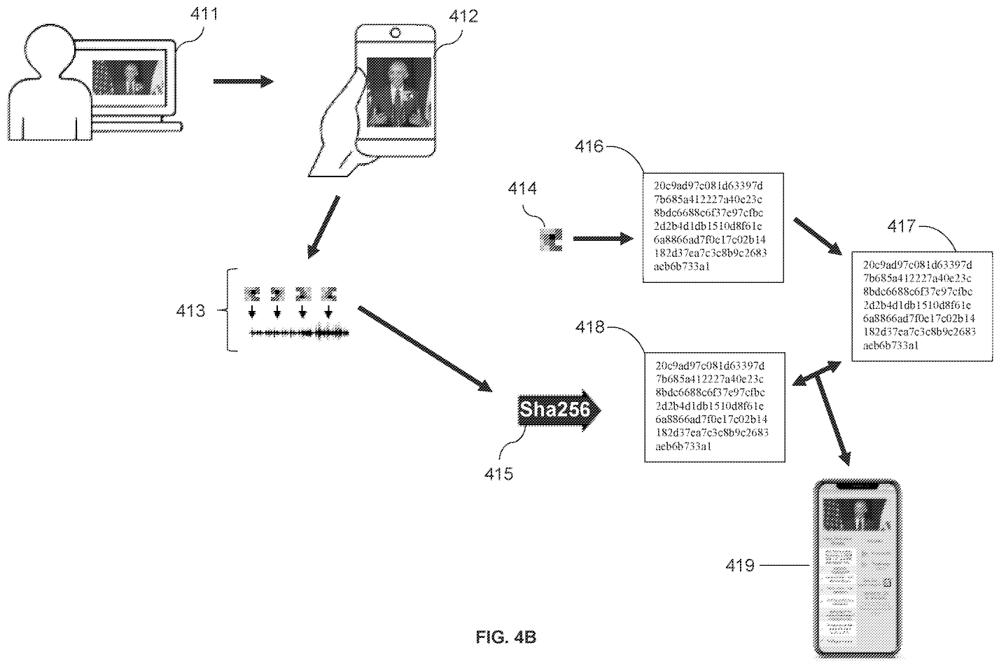

Referring to FIGS. 4A-B therein are shown a diagram showing exemplary aspects of a system for encoding (FIG. 4A) and for decoding (FIG. 4B). The system for encoding (FIG. 4A) may comprise an individual wearing a TrueBadge 401, a TrueBadge may receive ambient audio via a microphone 402, portions of ambient audio may be recorded 403, portions of audio are hashed 404, hashed portions of audio are then signed with the individual's private key 405, the signature is then displayed with the TrueBadge 406 and the TrueBadge immediately displays images encoding time-stamped audio portions 407.

The system for decoding FIG. 4B may comprise an individual viewing media to be authenticated 411, the individual may capture the media using his or her mobile device and present the media to a DeepAuthentic software application 412, the DeepAuthentic application reads and reproduces TrueBadge encoded audio 413, the TrueBadge present in the media displays images 414, the TrueBadge encoded audio is then hashed 415, the images produced in the media each have a unique signature that is decrypted using the media provider's public key 416, and the decrypted signature is compared with hashed audio portion 417 to determine if there is a match 418, and if so, the authentication may be displayed 419 on the user's mobile device.

The TrueBadge may be specially manufactured or implemented as an app on a smart watch (or smart screen) with a clip so it could be attached like broach or name tag or set on a dais or table. The display of the TrueBadge displays a template capturing both signed and encrypted information. Asymmetric keys are generated to authenticate device and user ID, digital signatures verify recorded data and encryption of some displayed data allows the user to selectively control what is shown on the display or broadcast to online services. The system delivers the following: (1) Authentication: Device ID and registration that cannot be spoofed; (2) Non-repudiation: In the default case, the user broadcasts immediately on the screen or relays the broadcast data online without secondary encryption, and the signed information about the physical environment, in this case the auditory environment, cannot be repudiated. As described below, users may opt to encrypt TrueBadge emissions and may or may not offer decryption. In such cases, the information about the physical environment is not made public. However, if the information is made public, the recorded information cannot be repudiated or doctored by the user or anyone else, because signed information is broadcast. The signed recorded data can itself be encrypted by users who may want to selectively release canonical data—but they will not be able to release fake canonical data; and (3) Integrity: it is not possible to alter the signed data, splice, reorder, or in anyway fake the broadcasted information.

### Encrypted Data

AudioIn: Audio recorded by the TrueBadge is recapitulated in the encoded display at a rate which ensures convenient video capture. There may be, for example, six distinct display frames per second, each displaying n seconds of audio, with an overlap of m seconds. The values of the display frame rate and duration of audio displayed in each frame, n and m depend on a variety of factors relating video sampling specifics and error codes. It is important to note that the encoded audio information is not displayed in “real” time or at a fast, quickly updated rate, because the encoded audio information must be displayed long enough to be reliably captured by video recording devices. For aesthetic purposes, non-encoding elements and properties of the display can change or animate at faster rates. Also, to further secure temporal integrity (i) m seconds of prepended audio force an ordering on the audio, ii) encrypted withing the template image are meta-data including elapsed time.

Sigs: Meta-data including serial number, and if registered the user ID.

Public Key Release Instructions (PKRI): This could be one or several. Some users may want to aggregate or disaggregate what is digitally signed or encrypted. For example, a user may want to maintain the ability to repudiate, and thus use a separate private and public key pair to encrypt the audio. This choice would be reflected in the TextNote field. Users may also want to keep location private or withhold all public keys, unless challenged. In some embodiments, the TrueBadge may display driving information. A TrueBadge user may not want their car's SEDW device to always display velocity information, but have the option to make it available through the appropriate public key. For instance, a TrueBadge user may want to display velocity information if wrongly accused of speeding. Options are set in app settings and/or users cloud account.

Session Name & Elapsed Time (SN&ET): Meta-Data displaying an arbitrary session name amended with GMT start time or GPS location, or only be a file name including GMT or a GMT+GPS location time-place stamp. The current elapsed time into the session is used for frequent display so an attacker could not re-order, compress/dilate or snip out moments of the speech. For further security, an optional meta-data function or reference to a function could be used to produce a relatively fast pseudo-random pattern that can further protect against splicing and re-ordering of video.

Cloud update information (CUI): Meta-data on update status and index of information the TrueBadge uploaded to the cloud. TrueBadges may upload high quality audio to the cloud (bandwidth of display constrains quality displayed). The TrueBadge may upload the canonical audio and only display an encrypted hash of the cloud based audio for decoder verification. The TrueBadge may upload other ambient information rather than display it on the TrueBadge. Cloud update information could encode verification that information was stored and where it was stored, for example in particular blockchains at particular times. However, note because the audio is fully displayed and signed with an on device pre-selected private key, there does not have to be an internet connection during speech.

### Unencrypted or Weakly Encoded Data

Error correcting codes (ECC): In particular, Forward Error Correcting codes and Reed-Solomon like error correcting bits so information on the TrueBadge can be reliably communicated, given that there is normally no reverse channel to request retransmission of data. These are codes applied to the coded encrypted message and are not ordinarily encrypted.

TextNote: Displayed or static. Directs to a website for more information on the device, including public key directories etc.

Image out depends on the image type, say a waving flag modulated by the output of two functions: ImageOutEncrypted (AudioIn, Sigs, PKRI, SN&ET, CUI) and ImageOutUnencrypted (ECC, TextNote).

In summary: (i) the audio of the speech is digitally signed with the Senator's ID and device ID credentials via private key(s), to protect the audio and prevent others from photoshopping in a TrueBadge that is not registered with the Senator. In some embodiments, the entire audio can be captured and rebroadcast as encrypted audio. Thus, verifiers do not need to depend on a cloud based canonical recording of the speech to verify the audio. To prevent splicing and reordering or insertions from other speeches, the start time, elapsed time and Session ID may also be encrypted with private keys. The encrypted data may be decrypted with public published ones. Unencrypted forward error correcting codes and encrypted and unencrypted metadata can be included in the broadcast. Again, in ordinary cases, public keys allow verifiers access to the protected audio, unless the Senator opts to keep public keys secret.

### Decoding: DeepAuthentic Video Verification.

A feature of the system is that if the canonical sound is displayed and public keys published by the user (to verify device ID and signatures), no one needs to trust a corporation or even a cloud repository with audio data to verify that the sound matches the TrueBadge display. Furthermore, the cryptography is such that the user cannot publish a fake public key which would produce any sensible output from the display (and as standard practice, standard verification functions check against such non-sense producing fake public keys, e.g. a check can test if the alleged public key produces a valid device ID, or any of various checksums).

If the canonical sound is not displayed, but online, the nature of digital signatures is such that DeepAuthentic can still publish its codec and open-source decoding, so that no-one needs to trust a decoding authority.

The TrueBadge decoding system connects to the DeepAuthentic Cloud and may (1) capture the display, error codes and redundancies, (2) extract unencrypted data, (3) extract encrypted audio, and (4) extract encrypted meta-data. The decoder user could among other things authenticate the TrueBadge; check the integrity of the video of the TrueBadge display; compare extracted audio with video audio by listening to both; offer the user an opportunity to listen to the TrueBadge displayed audio in full, at suspicious sections, or selected parts; and participate in TrueBadge website features which include commentary options, relevant news about the video, human assessment options, polls, and an array of features of interest to the community, especially regarding the policing of veracity.

In an exemplary embodiment, the unencrypted text note sends the decoder to the appropriate public key repositories. If the public keys fails to decode a test token, which when properly decrypted says “Valid”, then the public keys will produce non-sense or unreadable information indicating the TrueBadge is fake or spoofed. Next, the decrypted test token will indicate this to the decoder. A second validity check can compare an encrypted public key repository index with the encrypted one.

These repositories of public keys, which can be at well-known public key URLs, such as MIT, the speaker's website, or in the https information at the speaker's website, will allow the decoder to extract the Sigs information; serial number, unique user ID of registered owner, say this case, @realSenatorMarySmith.

AudioOut information may include audio of speech. From SN&ET the beginning and ending GMT date/time and place stamp, and elapsed session time may be determined, and an alert sent if the video was spliced, rearranged or time distorted.

From cloud information broadcast on the TrueBadge, information about what is online may be determined. In some embodiments, a TrueBadge may upload a high quality copy of the speech online, or inside of a time-stamped blockchain.

Decoding devices may be computers or mobile devices running apps upon video, or AR like systems which allow someone to point a mobile camera at the Senator's TrueBadge video. Such decoders may also remove or suppress distracting elements of the TrueBadge, so the video could be seen without the human distracted by TrueBadge dynamics.

### Cloud Services

The value of DeepAuthentic's system as an authority on veracity is derived from the ability to audit DeepAuthentic's cloud information and independently verify media.

A cloud-based registration and credentialing procedure links a user's identity with the TrueBadge, offers information management services, and generates one or more public/private key pairs for the user and his or her device. Details on the cloud components of this invention are described below.

Users have the option of generating their own secure link managed profile pages or using DeepAuthentic cloud services.

Data units and User Options Charts

| Kind | Name | Description, gloss, if necessary |
|---|---|---|
| Setting | DeviceSerialNumber | Of the SEDW or a registration number of the |
| | | app, or a concatenation or combination of a |
| | | software and hardware registration and serial |
| | | numbers. These values are non-repeating, |
| | | pseudo-random and do not require the user to |
| | | register the device with DeepAuthentic. |
| Setting | UserID | This variable could be a list and contains |
| | | information acquired during registration of the |
| | | owner. Users and systems can modulate how |
| | | much of this information is public. The UserID |
| | | is associated with private and public keys |
| | | which digitally sign and verify the SEDW's |
| | | media output. State-of-the art web-security can |
| | | use information derived from the UserID to |
| | | securely access cloud resources for decoders to |
| | | verify particular UserID sourced media output |
| | | and obtain information the User wishes do |
| | | disclose from their DeepAuthentic information |
| | | page. The UserID and an associated user |
| | | password is used to login and manage cloud |
| | | accounts. |
| Setting | ID | A value generated during registration which |
| | | combines DeviceSerialNumber with, if |
| | | available, the UserID. ID associated private |
| | | and public keys are used to verify that an |
| | | SEDW is legitimate or registered, and it is thus |
| | | associated with a private and public key for |
| | | digital signing. The ID is associated with |
| | | private and public keys which digitally sign |
| | | and verify the SEDW's media output. State-of- |
| | | the art web-security can use information |
| | | derived from the ID to securely access cloud |
| | | resources for decoders to verify particular ID |
| | | sourced media output and obtain information |
| | | the User wishes do disclose from their |
| | | DeepAuthentic information page. |
| Setting | Passwords | Passwords encoded in secure forms according |
| | | to best practices and stored to control device |
| | | access, initiating sessions, managing files, |
| | | connecting to mobile devices, networks, and |
| | | accessing secreted files. Some passwords |
| | | allow broad user access to Cloud accounts, |
| | | while others merely permit gust like access to |
| | | posted data or posting privileges. Passwords |
| | | automatically generated are state of the art, |
| | | changing and not themselves broadcast, rather |
| | | a hash or challenge-response system is used. |
| Input | RecordedDataStream | A list of lists each comprising data from |
| | | different sensors recorded over time. In the |
| | | case of the simple TrueBadge, a list of data |
| | | from the microphone recording audio pressure |
| | | over time. Location data can be included here |
| | | as telemetry sensor data out. |
| Session Data | SessionID | For convenience and added security a session |
| | | ID designates a recording period; e.g. a day, a |
| | | speech. The SessionID can be named by the |
| | | user and is associated with a unique |
| | | automatically generated value from a start |
| | | timestamp and ID. It includes start-time and |
| | | duration. It can also include a name selected by |
| | | an authorized user or location information. |
| Session Data | PrivateKeys | Dictionary of private keys paired with the |
| | | function of the PrivateKey. For the simple |
| | | TrueBadge, these PrivateKeys ordinarily |
| | | include the private keys for media digital |
| | | signatures, ID verifications (usually via hash), |
| | | UserID verification (via hash) and display |
| | | encryption. What a user selects to encrypt may |
| | | vary from session to session so different |
| | | private keys may be used on the same |
| | | TrueBadge for different sessions. GUI features |
| | | include user methods for managing many keys. |
| Session Data | PublicKeys | PublicKeys corresponding to private keys are |
| and Settings | | stored online or in private storage. They are |
| | | necessary for verification and integrate with |
| | | decoder applications. The set of public keys the |
| | | user publishes depends on what the user wishes |
| | | decoder audiences to decrypt. In the simplest |
| | | TrueBadge, a public key allows a decoder |
| | | audience to verify signed media and ID. In the |
| | | ordinary TrueBadge case described public keys |
| | | verify not just the displayed canonical media, |
| | | but UserID so that decoders know a genuine |
| | | registered SEDW was used and who the |
| | | registered SEDW device owner is. There are |
| | | methods for aggregating keys to shorten key |
| | | length. There are methods for managing |
| | | multiple keys that could for example allow the |
| | | user to release only specific subsets of |
| | | information (such as specific sessions or even |
| | | smaller snippets) or only unregistered ID |
| | | information such as DeviceSerialNumber (ID). |
| Session Data | StartTime | Start Time of a Session displayed as temporally |
| | | unique GMT and date. |
| Session Data | ElapsedTime | List with elapsed time within a session and |
| | | marking of a session end time. |
| Session Data | Templates | In the case of the TrueBadge, this designates |
| | | the animation which the MediaSnippet |
| | | modulates. For example in FIG. 3 an American |
| | | flag. Simpler templates include 2D barcodes or |
| | | other kinds displays output protocols |
| | | modulated such as radio signals, sounds, LEDs |
| | | etc. Templates govern the regular data format |
| | | and thus can be digitally signed. Templates |
| | | have ID codes so they can be easily designated. |
| | | There can be various kinds of Templates used |
| | | in a single session such as Templates used in |
| | | animation frames, Templates used for final end |
| | | of session displays and Templates for not-in- |
| | | session display. |
| Session Data | EncryptedMetaData | Lists can include formatting codes, options, |
| | | snippet capture duration, URLs, frame rate or |
| | | other text. |
| Session Data | UnencryptedMetaData | Can include secure link, error-correcting |
| | | codes, display template, orientation |
| | | information, frame switch indicator |
| | | encryption scheme name for display outputs |
| | | which do not need to be encrypted or for which |
| | | encrypting would make decoders unusable. |
| Session Data | CloudFeedback | Indicates success or failure of cloud uploads |
| | | and codes related to cloud uploading. |
| Output | AudioSnippet | Ordinarily the patent refers to MediaSnippets |
| | | (below) since SEDW devices record many |
| | | scene properties, but for discussion of the |
| | | exemplar, the TrueBadge in figures and below, |
| | | the Audio Snippet refers to the Audio only |
| | | component of the Media Snippet. The |
| | | AudioSnippet includes a snippet duration of |
| | | recording, which is generally longer than a |
| | | frame duration and can include overlapped |
| | | audio from earlier snippets. The Audio Snippet |
| | | data structure distinguishes the |
| | | contemporaneous snippet and the over lap |
| | | from previous snippets, so Canonical Media |
| | | and Session Data File can eliminate |
| | | redundancies. |
| Output | MediaSnippet | The media data digital signature and a hash or |
| | | media thereof encoded into one frame moment |
| | | of signal output--in the TrueBadge that is one |
| | | frame on the video display during a session. |
| | | Media data and its hashes and signatures are |
| | | distinct from metadata, in that media in this |
| | | sense refers to the version of the |
| | | RecordedDataStream displayed. Note, this |
| | | media could be a compressed version of the |
| | | RecordedDataStream or even a non-canonical |
| | | sound recording, if for example the user opts to |
| | | upload or store the canonical sound (which |
| | | would compose the ConnMediaData) and |
| | | display only a signed hash on the TrueBadge. |
| | | In the simplified Senator Alex example of the |
| | | TrueBadge, the media is the AudioSnippet. |
| | | Hashes or digital signatures of the media are |
| | | put into the MediaSnippet because they can be |
| | | proxies for the media in cases where channel |
| | | capacity limits or the user selects to with-hold |
| | | display of media. |
| | | The media captured in this snippet ordinarily |
| | | covers a longer duration of media than the |
| | | frame duration, so that successive frames have |
| | | overlapping content. For the TrueBadge |
| | | overlapping audio is one important tool for |
| | | preventing a malicious editor from re-ordering |
| | | video frames, since overlapping media forces |
| | | an ordering. Other SEDW devices can |
| | | similarly display overlapped recorded data. |
| | | MetaSnippet information or whole session |
| | | signatures can also protect against reordering. |
| Output | MetaSnippet | Ordinarily EncryptedMetaData and can |
| | | include SessionID, StartTime, |
| | | ElapsedTime, /EndTime ID, UserID, Frame |
| | | number, overlapping data or overlapping data |
| | | bashes, secure links and/or CloudFeedback. |
| Output | UnencryptedMetaSnippet | UnencryptedMetaData; such as error |
| | | correcting codes, urls for cloud services. |
| Output | DisplayedSnippet | Final image for one frame on the the |
| | | TrueBadge or one frame on the SEDW device, |
| | | which may be LEDs or a radio broadcast |
| | | signal. This can comprise the MetaSnippet, the |
| | | UnencryptedMetaSnippet, CloudFeedback, |
| | | and the MediaSnippet. All can be combined |
| | | with the template from Template to produce the |
| | | display image on a TrueBadge or display on |
| | | multi-modal SEDW device displays with |
| | | multiple output channels (e.g. sound, LEDs |
| | | etc). |
| | | No matter what a digital signature of CSV |
| | | information must always be recoverable from |
| | | the DisplayedSnippet (usually it will be piped |
| | | in through the MediaSnippet) for this is what |
| | | makes SEDW. |
| Output | ConnMediaData | Canonical media file. This file contains the |
| | | recorded information the TrueBadge or SEDW |
| | | device is signing. In the Senator Smith's |
| | | TrueBadge case, it is minimally an audio file |
| | | snippet, ordinarily, the audio information |
| | | displayed on a TrueBadge frame. |
| | | Generally, I will refer to ConnMediaData as the |
| | | most critical media since it is what is signed |
| | | and has its digital signature displayed on the |
| | | SEDW device. Except for an extraordinary |
| | | cases, the canonical media file data must be, if |
| | | not displayed, stored, hashed and signed |
| | | Because it generates the public hash used for |
| | | the digital signature. Complete veridicality |
| | | checking depends on not just on authenticating |
| | | the signature but also on comparing the content |
| | | of the ConnMediaData with purported |
| | | recordings of the scene. This comparison could |
| | | be done by human, the user, trusted human |
| | | groups or through developing AI. That is in the |
| | | audio case a human would compare the |
| | | uploaded ConnMediaData with the audio |
| | | coming from a suspicious candidate recorded |
| | | media image. |
| | | In a variation a user may wish to sign and hash |
| | | higher quality versions on sensor data. This can |
| | | be done by generating multiple canonical files |
| | | within the SessionDataOutFile to upload |
| | | higher quality or auxiliary media which could |
| | | also of course optionally display data which is |
| | | digitally signed on the SEDW device in |
| | | Templates accommodating this function. |
| Output | SessionDataOutFile | Is stored partially or wholly on the SEDW |
| | | device or the cloud when the user or default |
| | | options store multiple frames of recorded data. |
| | | Generally, it holds one session of data and |
| | | encompasses as much as all recorded data and |
| | | metadata, encrypted, the relevant public keys, |
| | | security information about session displays and |
| | | measurements g. temperature, |
| | | accelerometer readings etc.), secondary signed |
| | | and hashed canonical media files, frame rate |
| | | and overlap information and flankers |
| | | (StartFrame and EndFrame) displays. The |
| | | SessionDataOutFile could also be separately |
| | | encrypted, signed in parts or aggregate and |
| | | associated with a public key(s). Some |
| | | unencrypted metadata and transient snippet |
| | | signatures do not ever need to be stored, and |
| | | past security practice dictates that it is not. |
| Output | MenuScreens | Multiple screens constituting the GUI or user |
| | | interface protected by password or similar |
| | | security protocol (eg biometric), and used to |
| | | setup, select options, name sessions, manage |
| | | data, track sessions, review sessions, transfer |
| | | data, manage data on disk, cloud or personal |
| | | servers, and generally manage the SEDW |
| | | device. |
| Output | StartFrame | First frame of a session. Can display metadata, |
| | | encrypted and unencrypted data shown before |
| | | immediately successive frames showing |
| | | session media. In the case of video recordings |
| | | of a speaker with a TrueBadge- a missing |
| | | StartFrame or EndFrame raises suspicion |
| | | against the purported video recording of a |
| | | scene. |
| Output | EndFrame | An end of session frame which can be |
| | | displayed for a prolonged period marking the |
| | | end of a session and in some cases displaying |
| | | meta-data, encrypted and unencrypted, such as |
| | | a digital signature for the whole last session. In |
| | | many cases this can play a cryptographic role, |
| | | because its absence can belie a video of the |
| | | scene that purports to be complete. |
| Output | NonBroadcastingScreens | A list of displays indicating that the SEDW |
| | | device is not in an active session. Empty, |
| | | custom templates, or practical templates such |
| | | as a name tag (e.g. “Vote Jones”) could be used. |
| | | A clear “Start” or count down display would be |
| | | used to indicate that a session will soon begin. |

### Variations, Ramifications and Alternative Embodiments

This application is best understood as developing and focusing upon the invention of a new class of anti-deepfake technology; SEDW devices and related novel technologies.

TrueBadges are a class of SEDW devices that can be instantiated as stand alone devices or through SEDW applications running on other machinery.

Here I enumerate variations upon this embodiment, features and ramifications In some embodiments, the TrueBadges may have variations and added features with corresponding ramifications. TrueBadges can instantiate as applications running on mobile platforms, the web, within operating systems, within trusted video-communication apps, or other mobile apps (including vehicle computer platforms), and use either already produced or specialized hardware for recording, display or communication.

The display can attach to the user in a variety of ways.

Via a plastic clip designed to fit onto a smart watch or mobile platform display (e.g. APPLE's iPod Touch) and adhere it to a wearer's clothing, like a flag pin, broach, tie clip, shirt or suit jacket pocket clip, ID card toothed clip, reusable sticker or other method of attaching to the body of the user.

The plastic clip could be mass manufactured, distributed as a downloadable file for 3D printing, locally manufacture and assembled, or a combination thereof. The clip may be made of polyurethane or polyethylene.

Smart watch clips could attach to a watch in a variety of ways including through the strap string bar holding mortises. That is the straps could be removed and a clip attached to the strap spring bar mortices or through a device accommodating both straps and a clip adapter. Handles, tools, or interface modules and spring bars can facilitate attachment and reattachment.

Clips can hold a mobile device with the whole variety of adjustable and self-tightening grips such as those used in automobile accessories which grip a smart phone; including employment of adjustable tightening with springs, screws, velcro etc. Critically, the attachment clip has to keep the display attached to the individual. Thus, some high friction smart phone pads for cars would not be apt for TrueBadges.

Also, lanyard attachments, transparent plastic pocket windows integrated into clothing (such as hold ski maps or smartphones in ski jackets), an attachable pocket with window, reusable window pocket or cover attachment (such as velcro around the arm as is used to hold smartphones for joggers), upon a belt, hat, hair barrette, glasses, or any other separate attachment (e.g. upon a baseball cap).

TrueBadges could be directly attached to the body or even fully or partially embedded under-skin.

Clips and attachment devices can be integrated and permanently connected to a stand-alone TrueBadge device.

Modular attachment systems where the user can swap various kind of holders to an attachment module holder (e.g. so the user could swap out a clip for a pin or even a holder which does not attach to the body, but instead sits upon a desk are good fits.). Quick release spring bar straps have latches which facilitate removal of a strap or attachment to a watch spring bar mortise.

The display could also be held to a dais, held upright or angled on a table, held on a dashboard attachment, held on an attachment on the outside of a vehicle (like a magnetic siren or electronic “bumper sticker”), placed on a table, fitted with a flap or legs to unfold and angle the display on a surface, held to a wall, a ceiling or other architectural structure.

Holders can be robust, (e.g. behind bulletproof glass) and attached to architecture (e.g. to verify a landmark), with access to appropriate cabling for solar, battery, solar-battery systems, wind-power, grid or local power.

Holders and attachment devices could be more than mere clips, but hold external batteries, solar cells, or be colored, marked with text, designs, user photographs, barcodes, textural elements to facilitate ergonomics or have lock-ports, locks, or equipped with a springs or more sophisticated dampeners to limit display movement when the wearer (or vehicle, or attached object) jerks to prevent blurring the display.

Display interference: The display can also be equipped with anti-blurring systems which alter the display image on the basis of feedback from a 3D accelerometer or even devices which monitor the movement of cameras observing the display.

Cameras and light sensors can detect when an SEDW device's display is obscured and insert information possibly obscured into other frames, user may be alerted through vibration or sound.

All attachments and holders, including clipping systems could also include secondary power, such as a battery, wireless power system, USB or similar pluggable interface.

Holders and attachment devices could be clipped to other machinery, such as an interview microphone.

Some attachment methods will limit display options and such costs are considered in design. For example, transparent pockets interfere with a TrueBadge's backlight display or microphone fidelity. Work arounds include side lighting or microphones lines may need to be employed. TrueBadge management features apply to TrueBadges instantiated as stand alone devices or components of a mobile platform, such as iOS or Google mobile devices or hybrids, and, of course SEDW devices generally.

Power information for users: TrueBadges would indicate when battery is low, memory is low, or a subset of errors occur and an alarm could be expressed via video display message, flashing display, audible, haptic, vibrational, flashing lights or message to controlling device (such as a cellphone if a smart watch is used).

If TrueBadge is flipped or occluded, a proximity sensor can activate a similar set of alarms, such as flashing, sound, vibration or message to linked computing device.

TrueBadges could use front sensors to alert user if they are covered.

Display technologies: TrueBadge displays could use any of current or future display technologies such as LED, optical interference pattern displays, OLED, e-ink, LED arrays, curved screens, screens contouring to body, screens viewable at wide angles, screens that modulate brightness to match ambient lighting, and projectors (pointed at body or background or surface). Note, the latter are particularly useful if wearing a badge is inconvenient

Indirect information carriers: TrueBadges can use a lights on the side bezels facing backward and out (say about 45 degrees) to directly illuminate clothing and further push information and water mark the speaker or more of the scene via these light displays and reflected light from these displays.

Mirrors, lenses, or reflective surfaces on shirts and other surfaces could direct and reduce light loss from these back facing and bezel lights.

Recall the concept of a display for an SEDW device means that which is picked up by other recording devices, so it includes speakers, infrared transmitters, and all of these can benefit from multiple output channels, redirecting reflectors.

Locking and security: TrueBadges can be locked, long-key press locked, pattern locked, time locked, specific access locked, geo-locked, bio-metrically locked, local short distance radio locked, or remotely locked for various functions from preventing accidental responses to allowing an individual such as a journalist to lend a TrueBadge to an interviewee or to safely place an SEDW device down with ameliorated concern over a malicious actor turning it off, modulating it, etc.

TrueBadges can integrate motion detection and orientation change alarms, again to prevent accidental or malicious repositioning of the display.

Power settings: TrueBadge digital watermarking can be always on, activated manually, scheduled on, activated by voice, movement activated, vehicle state activated, activated by location or any combination of the aforementioned and/or integrated with battery saving technology with warned or unwarned automatic shutoff, dimming or power saving resolution and feature decrements.

TrueBadges can use a variety of power settings, adapt to ambient lighting and adapt performance from one setting to another, so a user, for example, can set one up for longer or shorter periods (e.g. all day or just an hour).

Alert blocking: TrueBadges integrated into mobile, telephony or automobile platforms can be set with options to ignore alerts and calls from other programs which would interfere with the display.

Continuity: In some cases TrueBadges may break, run out of power, or malfunction. Continuity systems enabled by allowing multiple TrueBadges to register with the same individual, connect to the same cloud accounts, or even securely directly communicate in the case of a timed swap, battery shortage, or anticipated swap, can allow a user to swap TrueBadges without interrupting the re-broadcast of ambient information.

Instantiations or more alternative embodiments of SEDW devices

The market and utility for SEDW devices is much broader and more significant than the protection of speaker reputations. SEDW devices are best thought of as informationally rich watermarks which when distributed around the world disrupt the falsification of all kinds or recordings. They build into our world an almost holographic universe where each SEDW displays re-present, with modern cryptographic integrity the state of the immediately surrounding world, and sometimes beyond.

Time/Location verification: SEDW devices can be placed at concerts, tourist destinations, courthouses, meeting centers, hard to reach high status destinations to verify selfies and recordings with the SEDWs in the background.

Such SEDW devices can on their displays not just cryptographically sign and redisplay sound information, but image information as well, such as that of the selfie-takers, the weather, mean coloration, the date, DeepAuthentic Cloud entries with advertisements etc.

Critically, the advantage over “natural markers” such as the shadow of the Washington Monument during a protest, is informational richness that cloud connectivity, and cryptographically enhanced re-display of ambient information allow. This provides utility far beyond forensic natural markers.

Clothing: SEDW devices can be embedded into clothing to show past location, velocity information, metal detection, acceleration, orientation history and other information.

Such clothing could exonerate or condemn those wrongly shot by law-enforcement or criminals.

More importantly, such clothing could decrease such violence and detour reckless behavior, since SEDW clothing and accessories could be counted on to testify to the veracity of the action.

Furthermore, since such clothing represents these abilities, hoodies and many kinds of fashionable clothing that re-assure truth broadcasting could be made and sold.

To save energy, lights and displays from such clothing could be activated by heart rate, sirens, screams or other indicators of danger.

Multi-sensor equipped TrueBadges: SEDW devices with cameras can encode more than merely sound, such as audience, other interlocutor behavior, and catch attempts to manipulate the video of a dishonest interviewer or interlocutor who would manipulate video.

Distance sensors, whether ultra-sound or lidar, record even more and protect more of the scene from malicious manipulation.

SEDW devices can be equipped with 360 degree cameras.

IR sensors, and devices which read the vitals, voice tones, facial expressions of other human antics would provide SEDW devices with clues about volitions to rebroadcast, capturing in many situations more than mere cameras and aiding the resolution of disputes arising from disagreements about the interpretation of an agreed upon veridical video.

Other things for SEDWs to perceive: SEDW devices should be able to read ID tags, weather information, information from off-scene SEDWs (though this can sometimes be done more efficiently through radio) video capture of triangulated readings are more perspicuously validated since they do not depend on invisible signaling.

Shipping and luggage label SEDW devices could broadcast temperature history, accelerometer history to ubiquitous cameras at airports and shipping centers to help zero in on misconduct and prevent managers or malicious actors with access to surveillance systems from altering the surveillance footage.

Dash cams are becoming ubiquitous as is increasingly cheap deepfake creating technology, and thus the probability of tampered dash-cam footage to misdirect vehicle accident blame. Every vehicle could use SEDW devices using electronic bumper stickers or LEDs, attached to bumpers, against windows, or more fully integrated in cars. Their displays would broadcast location, time, velocity, acceleration, positional data, even lidar and camera information, all digitally signed with time stamped snippets to protect against deepfakes of car accident footage. This may be the most useful and profitable near term application of SEDW devices.

Every vehicle could use SEDW devices to record and rebroadcast movement, lidar, camera information, sound, position, history, braking or accelerator behavior for rebroadcast on displays ranging from electronic bumper stickers, displays on rear windows, side-panels or fully integrated in cars at manufacture. Accidents are expensive in lives injured or lost, and as the proliferation of dash-cameras testifies, those in accidents are not forthcoming with the truth. Given the enormous cost of such accidents there is tremendous motivation for unscrupulous actors to tamper with dash-camera footage and technology for doing so is becoming increasingly available and cheap. This may be the most useful and profitable near term application of SEDW devices.

Vehicles are meant to include bicycles, hoverboards, aircraft, drones etc. And, wearable SEDWs can be designed especially for or amended for protecting pedestrians from deepfakes.

Government and corporate vehicles should integrate SEDW devices to facilitate civilian surveillance.

Police should integrate TrueBadges with their equipment or the devices should be integrated with already powered wearable cameras, a synthesis which would save on hardware and other technical overhead.

SEDW devices which display through subtly altering the sound scape or lighting systems encoding a personal location and/or recording information there-in can protect against malicious actors alleging untrue intimate activities occurred at those locations. Celebrities or victims of malicious synthetic media and deepfakes could use SEDW sound and light emitters where-ever they go to cast doubt on deepfakes alleging impossible actions.

SEDWs can be integrated into watches which flash merely identity information or even intimate apparel and furniture.

SEDWs do not need to broadcast bright displays to be effective, small variations in light, say performed by a digital IOT lightbulb connected to a SEDW device can verify facts in a scene.

SEDW devices can project subtle lighting on speakers, on audiences, add sounds which are inaudible to humans, but easily teased out of recordings.

SEDW technology can be built into phones and subtly play sounds which do not interfere with the voice that are barely heard (masked sounds) but which can protect users from fake voice recordings of phone calls.

SEDWs can record from any sensor or sensor sets, including EEGs, EKGs, skin conductance and display the information through anything from lightbulbs in the room, head lamps, electronic lapel pins, illuminated clothing, bicycle head lamps, car bumper stickers, motorcycle helmets, vehicle lighting to track biometric information such as attention, alertness, fear, heart rates, and information which has not yet been reliably recovered from these biometric sensors but which can be in the future. Note such information would be valuable in accident analysis, but also for measuring the safety of roads or zones in ways which would be hard to challenge.

Lighting systems can be integrated with SEDW devices which project onto the subjects or crowds data.

SEDW devices which display through subtly altering the sound scape or lighting systems encoding a personal location and/or recording information there-in can protect against malicious actors alleging untrue intimate activities occurred at those locations or even others, if users are vigilant and record their vigilant daily use by using the SEDW devices to track and evidence daily use. (e.g. a biometric ID is read everyday to show an individual is under the umbrella of an SEDW everyday). Celebrities or victims of malicious synthetic media and deepfakes could use SEDW sound and light emitters wherever they go to cast doubt and expose deepfakes alleging impossible actions.

SEDW devices can be integrated into watches, rings, head-wear, room lighting, intimate apparel, furniture, blankets or pillows to subtly flash my light or sound identity information. Subtlety can be low power, by near matching of ambient light and sound, or by broadcasting in spectrum which cameras and microphones record, but are not detectable by people (e.g. infrared or high pitches). Near-matching may provide a carrier signal that is similar in frequency or color to ambient conditions or which use psychophysical tricks such as masking against ambient conditions to reduce salience which could distract people in the SEDW device umbrella.

SEDWs do not need to broadcast bright displays to be effective, small variations in light, say performed by a digital IOT or wireless lightbulb or lighting system connected to an SEDW device can serve as the “display” for use in verifying scene facts. Such a system is one of several SEDW setups (such as the one above) that can be used to protect potential victims of deep-fake pornography. As a defense against deep-fakes victims can engage in intimate activities only in places with SEDWs verifying the potential victims actual presence. And, since data is hashed and can be selectively released via selective publication of public keys decryption, there is considerably less of a threat of leaked video.

The leaked video problem can be complete avoided as well. For example, the SEDW device can record only parts of scenes, say 5% of pixels randomly distributed (and even changing over time) but with locations exactly recorded as the conical file that is hashed. More generally, the signed canonical file does not always have to be the whole image, just enough to rule out inauthentic purported representations.

This extra-layer of security does introduce risks, but are manageable. For example, if too much is leaked.

Partial recordings could be processed through compressed sensing systems to produce whole scenes-so if one is concerned about such a leak, recording should be under 10% of pixels.

Partial recordings if leaked could allow a malicious actor to fake what is in between the pixels recorded for the hash, and thus those fakes derived in combination with partial recordings, though extraordinarily difficult to produce, would share the same hash.

A third strategy is to record the entire scene for the hash, but then immediately encrypt the recording with distinct private keys for very selective partial release if challenged.

While, this specification has described the failures of putting watermarkers in cameras, SEDW devices could be attached to cameras or other devices and as the display project lighting or sound onto a scene. These projected lights or sounds could be salient or subtle, and still be teased out of recordings for verifications.

SEDW technology can be built into phones and subtly play sounds which do not interfere with the voice, but are barely heard (or are masked sounds, played according to a published function) which can protect users from fake voice recordings of phone calls.

SEDWs can record from any sensor or sensor sets, including EEGs, EKGs, skin conductance and display the information through anything from lightbulbs in the room, head lamps, electronic lapel pins, illuminated clothing, bicycle head lamps, car bumper stickers, motorcycle helmets, vehicle lighting to track biometric information such as attention, alertness, fear, heart rates, and information which has not yet been reliably recovered from these biometric sensors but which can be in the future. Note such information would be valuable in accident analysis, including the use of pedestrian and driver attentiveness. And, could also be used to evaluate the safety of transport networks in ways which would be hard to challenge, since video of the incidents would hold SEDWs.

Encoder as software controller app:(i) TrueBadge hybrids, (ii) Sensors to stabilize image if moved, (iii) SEDW, (iv) General mobile control, (v) speakers, (vi) LED room lamps, (vii) LED car displays, (viii) LED auto lamps, headlights and rear lights, (ix) application on smart watch, (x) separate device, (xi) composition, (xii) backlights, (xiii) throughout patent “device” refers to machinery SEDW whether as software on a platform or a stand-alone-device, unless otherwise specified, (xiv) Sound for phone calls, audio watermarking, (xv) Smart watches (with clips, lanyards etc.), (xvi) Stand alone devices (better security and battery power), (xvii) Clothing (with cameras), cars, (xviii) clothing (information such as: momentum, hand position, location, bullet hole), police, vehicles, and pedestrian shoes that light up with automobile speed.

Cryptographic variation: (i) Protocol code variations, (ii) 1 digest(=hash output) to multiple digests, 1 to multiple signatures, (iii) protocol code space (along with header information), (iv) padding, salting, different hashes, different signature sets, (v) Secure logging and database access, (vi) Best practices, (vii) Credentialing from 3rd parties such as FACEBOOK® or APPLE®, (viii) Hashes, hash methods are as a matter of best practical publicly committed to. Else one can suspect that a user retro-fitted a hash from the private key and digital signature to fit the canonical media. This can be done through the ID information, it could even be cleverly inserted into information the digital signature signs, (ix) Subsets of what is signed, serial number, name, GPS etc., (x) continuity chain, (xi) Encoding Methods/Verification Methods, (xii) Separate parts of the system. Several of each. (xiii) Encoding quality of ambient features on device, for upload and use: high quality audio-.compressed-→lossy compressed—→checksum type verification, (xiv) Disaggregation Options, (xv) Public vs Controlled release OR selective disclosure, not selective non-repudiation. Options chart. Or disclosure by authority or upon death or accident only, (xvi) Anyone can verify-→only a limited set only a limited set after authorization→everyone after authorization, (xvii) Withholding private or initiate information, unless challenged or unless permitted or unless multiple parties agree, (xviii) And authorization can be for any subset of the information; categories, events or time splices of events.

Input: Sensors and Kinds of Ambient information: (i) Sound including voice, (ii) Visual features, (iii) Time, (iv) GPS coordinates, (v) Accelerometer readings, (vi) Serial number of device, (vii) Authorized user information or real name verified, (viii) weather, pressure, temperature, (ix) proximity to other devices, (x) metal detection, (xi) EEG, (xii) Output from machines, such as screens or speaker such as video game levels, (xiii) This can even be done with small sensors such as inside a VR or AR device or around an earphone.

Output: Placement of information of ambient features. Where does TrueBadge output go. e.g. a checksum of what's online. (Note that technically the SEDW device does not have to be captured in the scene only its display and SCVs (specifically coded values): (i) LEDs, (ii) Ambient information presented so information is captured and cryptically re-displayed for recorded scenes, (iii) Visual displays to be recorded, (iv) As in first case of displaying an image on the pin, (v) Displays as IR or in other spectra, (vi) Audio displays recorded scenes, (vii) See audio displays, (viii) Ambient information redisplayed as a hash only, (ix) Disadvantages of comparing non-canonical versions, (x) So it must be a kind of hash of a fuzzy canonical version, (xi) AI methods which use, something like dictated text as an imperfect hash, (xii) AI methods which run a hash on a fuzzy neural network representation, that is a hash pointing to subspaces of a neural network representation such that the “Canonical log” is actually everything that activates a particular weighted sum of subspaces, (xiii) Correction of Psychophysical and mathematical compression, (xiv) Switches to accommodate as options, including RAW video or various HD standards or HDR standards 4k and 5 k standards, (xv) Randomization, (xvi) Human visible colors, (xvii) feedback mechanisms and feedback routines to evaluate encodings and improve so that information lots to compression is minimized, (xviii) ongoing research on compression, (xix) Display types, (xx) e-ink, (xxi) holographic, (xxii) butterfly type OLED, (xxiii) color profile generally or grey scale or black and white surfaces planner or mainly planer, (xxiv) tubes to darken in bright environments, (xxv) Ambient information signed and stored, (xxvi) On information storage device in the TrueBadge, (xxvii) Over radio to an internet repository, (xxviii) Into a blockchain, (xxix) Broadcast as radio and stored on nearby devices running a TrueBadge app or compatible anti-DeepFake signature generator. This helps TrueBadge work even if framed-out of video, (xxx) Laser, cable or line of site line to storage device or the internet for website or blockchain storage, (xxxi) Printed or formed physical object, (xxxii) Ambient information partially stored, or uploaded or displayed. Subsets of the canonical media file could go to different places. e.g. sound out while light information uploaded, (xxxiii) Combination of a & c (xxxiv) e.g. partly redisplayed with higher quality uploaded/stored, (xxxv) Canonical version stored/uploaded with only hash re-displayed, (xxxvi) Ambient information Locally Broadcast, (xxxvii) To nearby devices running TrueBadge apps, so there are many local copies, (xxxviii) A hash of a stored and possibly distributed high quality canonical audio is displayed, (xxxix) A hash of high quality media is displayed, (xl) entirely—partially-Machine Learned robust to compression signature—hash only on pin and the rest in a private repository, public repository, block chain, or physical record, (xli) Verify amount in proprietary network, (xlii) Meta-data may include, (xliii) Variations of Display media and metadata OUTPUT, (xliv) Visual display types, (xlv) EM: Visual and non-visual irradiation: screen on broach device, illumination, background image, other screens, LEDS, non-visual spectrum, speaker illumination, semi-transparent crowd screens with “noise” features, Devices to warn nearby participants, or on the back of teleprompter displays. Screens similar to cc, (xlvi) Audio display types, (xlvii) Auditory to Vibrational: e.g. slight vibration of a desk, masked sounds, sub-audible sounds, natural sounds discreetly mixed into the scene, (xlviii) Frames can be further broken up to provide more information, (xlix) Robustness of watermark display to account for variations in resolution & compression, (l) sharp color pixels, infinite speed—→gross, redundant, high contrast and large, (li) Discreetness, (lii) Methods for avoiding distraction: equiluminance and auditory hiding, (liii) Non-visible spectrum, (liv) Designed to be filtered-out by decoder system, (lv)Variations of device INPUT, things encoded, (lvi) video/audio/accelerometer/location history/metal/GPS/temperature/wind direction/3D video/3Daudio/bodily movements, camera out, (lvii) peripherals cameras for facial expression and bodily movements, (lviii) multi-angle, from other distal devices such as other cameras from behind for Zapruder film, (lix) Directional microphones, (lx) Use of internet or blockchain time-stamping.

Security features: However, notwithstanding the difficulty of theft TrueBadges can include security features of modern cellphones and smartwatches. The TrueBadge can be remotely disabled, locked or located by GPS. The TrueBadge can also send alarms of displaced and/or deregistered devices via associated cloud services (if remote disabling is blocked by radio barriers) and require passwords to initiate sessions: (i) PW to turn on, (ii) session id's, (iii) defenses from directed audio attacks, (iv) defenses against directed beam attacks, (v) Website features, (vi) sign-up, (vii) registration, (viii) Identity authentication, (ix) information on suspicious or fake videos in circulation, (x) options to download features, such as animated images, (xi) Camera embedded apps which work with TrueBadge, (xii) Inadequate, but in combination useful, (xiii) For it could encode information from the TrueBadge within the photo in a less distracting way, (xiv) The encoding of the new picture or video or sound could be checked against a record of the TrueBadge activity, (xv) Encoded into the record, (xvi) Camera systems which do 3D scanning, (xvii) And integrations of such systems, (xviii) Product General Features of simple display, (xix) Color band for calibration, (xx) Border for orientation. Or orientation helping, (xxi) e-ink versions for bright environments, (xxii) patterned near real time displayed animations which can be used to reveal a time-cut, (xxiii) Related features, (xxiv) Plagiarism and copyright protection features for comedians, (xxv) Searches internet and places speech or speech hash on internet, (xxvi) TrueBadge and similar tech is turned on via, (xxvii) password or biometric activation, to connect device to an individual, (xxviii) non-password activation for merely serial number+ambient information, (xxix)low-power warning, in case battery goes out, (xxx) Decoders embodiments, (xxxi) built into TV or video systems so that Pin-screen is blocked out and verification checked while watching, and in addition to YOUTUBE®'s features, (xxxii) As an app on phone which can look at TV screen for verification, (xxxiii) As an app in AR systems, (xxxiv) blocks ambient signal e.g. a distracting TrueBadge display, Decoder features: (i) Error correction, angle correction, (ii) Accesses relevant storage devices for permissions, (iii) Access relevant storage for data that may be stored in cloud or on disk, (iv) Blocks out or fills in TrueBadge display, (v) Display veracity or alert if fake, (vi) Displays accessible information from the TrueBadge display (e.g. time), (vii) Displays or produces the canonical sound, (viii) Looks for differences between canonical and recorded, (ix) And if imperfect, according to a sliding rule, alerts, (x) Gives comparative option, (xi) Checks if source video is verified via a secondary certification service (e.g. a human or other entity could certify video versions), (xii) Uses overlapping information to reconstruct data from lost frames, (xiii) Uses overlap hashing. Hash of data displayed. data from some time ago.

### Summary of SEDW Devices, Infrastructure & Processes, and Claims

From TrueBadges toward Ubiquitous Authentication via the Encoded Rebroadcasting of Reality

Examination of the simplest TrueBadge offers the best insight into these novel SEDW devices. Typically, the TrueBadge displays signed information in an animation of encoded frames of conical signed overlapping sound snippets, error-correcting codes, timestamps, registration information and meta-data such as session number, GPS information, URLs for verification (to compare with unencrypted URLs), signed error-correcting codes (to prevent error correcting spoofing), and optional unencrypted data such as websites URLs, closed-captioning etc. Similar to the way in which products like DOCUSIGN® endorse static text, one can think of the TrueBadge as verifying the audio component of a dynamic scene.

Recording video of the scene captures with it a signed rebroadcasting of the scene's audio information displayed on the TrueBadge. Any attempt to change the audio would require changing the TrueBadge display, but that is cryptographically impossible as consequence of the one-way functions that make the owner of the TrueBadge the only one who can produce the public keys for verifying the signature for the scene sounds. Ordinarily, such public keys will be posted on reliable sites. Fakers cannot get their dubbed sound signed or produce the registrant's signature, and the overlapping snippets and timestamps make slicing and reordering operations impossible as well. The TrueBadge detailed in this specification is an exemplary SEDW device and serves as an introduction to more generalized SEDW devices, applications, and infrastructure.

For reasons of economy and understanding, the TrueBadge device is described, but the device at the center of the patent is the SEDW which is best understood as an elaboration of the TrueBadge along two main dimensions: (i) the medium of display, and (ii) the aspects of the local scene captured by the SEDW. Additionally, SEDWs including the TrueBadge can record (encrypted and unencrypted data) and upload data, again by all practicable and preferably secure means.

An SEDW device applies the novel trick of signed or encrypted rebroadcasting (with overlapping information, time-stamps, and other meta-data) but utilizes a vast array of displays, where the term “displays” are used to describe any useful contemporaneously detectable change or broadcast of energy that current technology could detect by another recording device scanning the scene. For example, this can be an OLED screens, pulsating lightbulbs, audible and inaudible sounds, temperature changes, shape changes (such as those induced by fluids, magnetic, or electro-mechanical means), infrared light, laser projections, radio etc. The device presents on the display in real time an animated digital signature authenticating overlapping snippets of sensor data or encodings thereof concatenated with time stamps.

The SEDW may be configured to record anything contemporaneous sensors detect, so long as there is enough variance to be of use to extract signal data, sound, light, accelerometer data, muons, etc. In principle, if it can be detected in a scene an SEDW can be configured to detect it and its variation for encoded rebroadcast of scene information. “Encoded” in these contexts can mean signed, encrypted, hashed or fingerprinted. Ultimately, the output is always some signature of scene data. However, users may opt to encrypt the signature in the final output, or bandwidth restraints may require a “double-hashing.” In such cases instead of a digital signature as the main display output, that signature is hashed to save bandwidth and the verification process goes from hash to signature to hash to data, with the hash stored at a centralized or authenticable website linked to the SEDW primary user.

The TrueBadge is a simplified version of an SEDW, which minimally records sound, (but as noted in alternative embodiments, may also record GPS and other data).

### Infrastructure and Processes

Scene recordings taken by anyone should capture the conspicuous displays of SEDWs and the scenes SEDWs are embedded in. Scene recordings that omit the displays of SEDWs should be regarded as suspect, and thus the invention generates a virtuous norm; to maintain a good reputation individuals and media groups should use SEDWs, and individuals such as politicians who do not, and media groups that record scenes while avoiding SEDW displays, risk their epistemic reputations. SEDWs are designed to move significantly toward killing off both the deepfakes and eliminate the liar's dividend, and thus enable, and by its existence encourage, improved epistemic hygiene for those intent on distributing recordings.

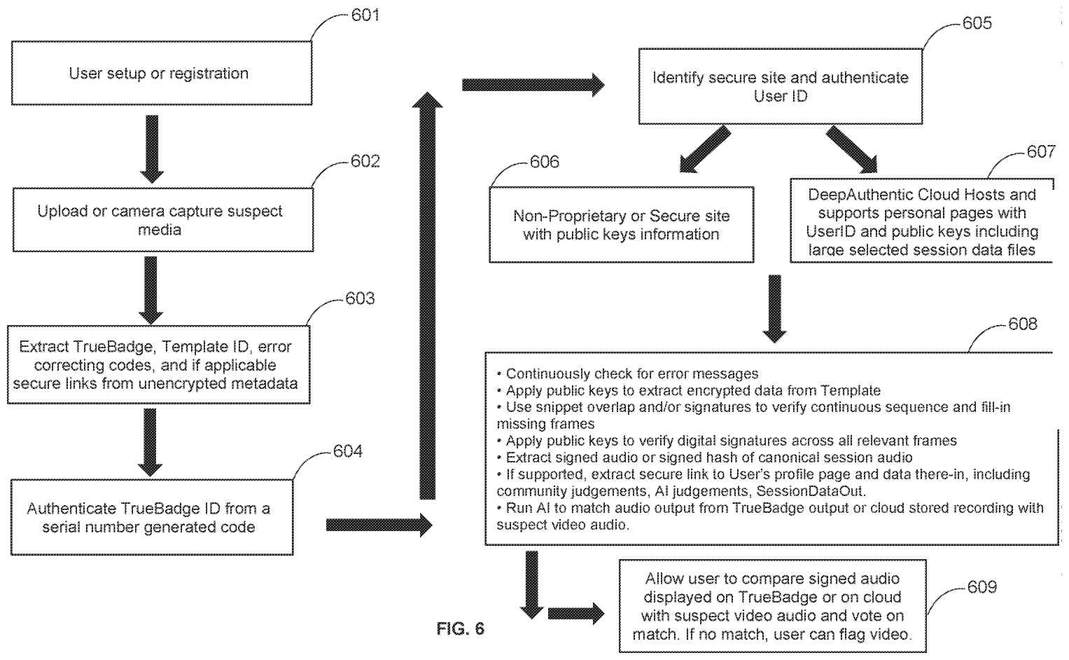

The process of verification described above is designed to be a wide but enumerable set of verification methods. Again, returning to the simple TrueBadge, the easiest method is illustrated in FIG. 6. At step 601 the user is set up or registered. At 602 suspect media is uploaded or captured by a camera. At 603, the TrueBadge, template ID, error correcting codes, and secure links, if applicable are extracted from unencrypted metadata. At 604, the TrueBadge ID is authenticated from a serial number generated code. At 605, a secure site is identified and the user ID is authenticated. Public keys are obtained from either a non-proprietary or secure site 606, or from cloud data (e.g., in a DeepAuthentic Cloud) 607. At 608 a number of extraction/verification processes occur (e.g., for error messages, applying public keys to extract encrypted data, verification of continuous sequence of frames and filling in of missing frames, verification of digital signatures, extraction of signed audio or hash of session audio, extraction of secure link to user profile page, and running an artificial intelligence program to match audio output from TrueBadge output or cloud stored recording with suspect video audio). At step 609, a user may compare signed audio displayed on TrueBadge or in cloud with suspect video audio and vote on whether there is a match. If there is no match, the user may flag the video.

Generally, the candidate TrueBadge information is tested against published keys and hashes to:

Authenticate the registration ID of the TrueBadge from the company issuing the SEDWs.

Authenticate the registered user.

Validate the order of time signatures, which contain hashes of the registration ID of the TrueBadge and of the registered user along with encoded clock data to deter re-ordering, splicing, and stamp the entire sequence.

Validate the continuity of the sequence, which is achieved by the display broadcasting overlapping snippets of recorded data, to deter deletions.

Validate that the audio displayed is audio encoded by the TrueBadge.

Validate that there are no errors, (e.g., to prevent spoofing by the generation of fake error-correcting codes). That is the checksums or error-correcting methods visible must be the same as those signed or encrypted.

Compare (by users, AIs, users with trustworthy points/reputations, AIs with trustworthy points/reputations) the audio from the suspect video with that from the TrueBadge.

This specification further enumerates other methods of verification necessary to accommodate social interests in decentralization, and personal privacy interests.

As an alternative to hashing of session audio (audio of an actual event or occurrence), or media audio (e.g., audio from a video to be authenticated), an audio fingerprint may be made for use in conjunction with a TrueBadge or other SEDW. To make an audio fingerprint, an audio file is converted into a spectrogram where the y-axis represents frequency, the x-axis represents time, and the density of the shading represents amplitude. For each section of an audio file, the strongest peaks are chosen, and the spectrogram is reduced to a scatter plot. At this point, amplitude is no longer necessary. Now all the basic data is available to match two files that have undergone the fingerprinting process. However, it is only possible to match them if a user began recording at the exact millisecond that an audio session began.

Since this is almost never the case, there are additional steps to audio fingerprinting. Through a process called combinatorial hashing, points on the scatter plot are chosen to be anchors that are linked to other points on the plot that occur after the anchor point during a window of time and frequency known as a target zone. Each anchor-point pair is stored in a table containing the frequency of the anchor, the frequency of the point, and the time between the anchor and the point known as a hash. This data is then linked to a table that contains the time between the anchor and the beginning of the audio file. Files in the database also have unique IDs that are used to retrieve more information about the file such as the file content or title and the user/speaker's name.

Because the codec for SEDWs is public (to accommodate the principle that the best cryptographic methods should not be secret and because SEDWs are not bound to any specific hash, public key, convolutional, or encryption algorithm), it can adapt as new decryption security threats arise. Thus, codecs may be published (a) for the sake of trust, (b) to enable open-source verification, and (c) to enable private SEDW owners to set up private verification sites. Thus, users may opt to place verifying keys on a variety of servers, their own or corporate servers, existent public-key and hash registrars, or in some cases, should the individual find prudent, their own personal, even air-gapped storage devices, and only publish public keys for signature verification if desirous of showing evidence.

To enumerate hyper-private variations some users may wish to remain anonymous and not register their SEDWs, or reveal that they own SEDWs. This is not problematic since hardware/software or more precisely something like a product ID would suffice as a private key source. It is even possible for the user to use neither a user registration nor a product registration for private key(s), and privately generate their own keys, which they could hide in a block-chain, the SEDW device, or other storage media in case of challenge. The hyper-private cases preserve critical features to falsify deepfakes but may benefit SEDW users who may only want to maintain full non-repudiation in the case of challenge or desire to repudiate, and not publicize in anyway ownership of an SEDW or be willing to sacrifice the non-repudiation feature for personal reasons. Of course, such excessive confidentiality will open and should open the users who use SEDWs in these heterodox ways to epistemic criticism and suspicion. But there are financial and reputational cases under which one would not even want to post data or even suggest they use an SEDW device. Recall the broadcast of an SEDW display can be paradoxically, but without contradiction, both conspicuous to recording devices, but hidden, such as hidden steganography in overlays of background noise, images, or subtle variations of lighting and encoded data, and that compressed, salted, hashed, and encrypted signals are practically indistinguishable from noise.

The market and utility for SEDW devices is much broader and more significant than the protection of speaker reputations. SEDW devices are best thought of as informationally rich watermarks which when distributed around the world disrupt malicious synthetic media of all kinds, and in ordinary use cases prevent repudiation and the liar's dividend (unless otherwise noted, described are the ordinary use case with public keys for verification published). SEDW devices build into our world an almost holographic universe where each SEDW device displays re-presents, with modern cryptographic signatures authenticating the states of the immediately surrounding scene.

### General Description of Claims

The present invention generally comprises the central SEDW device, various applications and embodiments, a process infrastructure and user-settings.

More specifically, the wearable TrueBadge comprises a display, and audio recording capabilities, which can protect a public figure from deepfakes when consistently worn. The TrueBadge accomplishes this goal by presenting in its display a succession of images, such as 2-D barcodes or data steganographically encoded in, for example, a waving flag, containing a signature of a hash of the ambient audio and meta-data along with a hash (or fingerprint) of the audio and meta-data and in some cases, where bandwidth allows, an actual encoding of the audio. Audio in video of adequate (but ordinary) resolution of a speaker and their conspicuous TrueBadge can be verified as the audio in the veridical visual-auditory scene recorded via a comparison with the data displayed on the TrueBadge, and audio in the video purported to capture the scene.

Typical embodiments of a display badge generally comprise: (i) an audio detection component, the component detecting at least a portion of ambient audio data of an actual event; (ii) a computing device operably connected to a recording component, the computing device converting at least a portion of the detected ambient audio data into a digital representation of the at least a portion of the ambient audio data; (iii) a display presenting a succession of images comprising the digital representation, where the display badge is designed such that the digital representation is sufficiently visible that it may be extracted by a computer upon replay of audio and video of some or all of the actual event, and the replay audio may be verified as authentic by comparing the digital representation with the audio associated with the replay.

In some embodiments, the at least one of the succession of images may include metadata, and the metadata may be signed. In addition, or alternatively, the metadata may include a unique serial code for the display badge, a randomized registration code linking the display badge to a registered owner, a session ID code, a date or time of the actual event, or an elapsed time of the actual event.

In some embodiments, the digital representation comprises a fingerprint of some or all of the audio data. In other embodiments, the succession of images further contain at least one digital signature.

In some embodiments, the digital representation may be hidden within one or more images utilizing steganography or may be presented in a specific portion or portions of the visual spectrum. In certain embodiments, the specific portion or portions of the visual spectrum include at least visual data transmitted in wavelengths outside of the range of human visual acuity, for example, less than approximately 380 nanometers or greater than approximately 750 nanometers. Further, in some embodiments, the digital representation contains at least some recorded audio.

Methods for encoding media data in a display badge typically comprise: (i) detecting, by an audio detection component operably connected to the display badge, at least a portion of ambient audio data of an event; (ii) encoding as all or part of one or more images, one or more digital representations of the at least a portion of the ambient audio data; (iii) hashing the at least a portion of the one or more digital representations; (iv) signing hashed data with a private key; and (v) displaying the one or more images and the signature on the display badge.

In some embodiments, the methods may further comprise signing each of the one or more digital representations. In some embodiments, the hashing method may be fingerprinting. In some embodiments, the display badge may be a mobile communications device, or operably coupled to a mobile communications device.

Method for authenticating media data typically comprise: (i) capturing media data to be authenticated, where the media data includes video of a display badge containing an encoded first hash of one or more recorded portions of audio data of an actual event; (ii) identifying the encoded first hash; (iii) creating a second hash of some or all of the audio portion of the media data; (iv) comparing the first and second hashes; and (v) determining, based on the comparing, whether the audio has been manipulated or altered between a generation of the first hash and a generation of the second hash.

In some embodiments, the first hash includes a digital signature generated using one or more private keys, and the method further comprises applying one or more public keys to verify the digital signature. Additionally, some embodiments may comprise authentication of a user prior to initiation of authentication of the media data, and in further or alternative embodiments, the hashing method may be fingerprinting.

In typical embodiments, an animation of roughly 8 frames per second, steganographic or encoded in existing open-source 2-D barcodes, such as Java Access Bridge (JAB) in as few as 10×10 large color pixels, displays on a lapel pin display roughly the size of a large APPLE® Watch.

The display presents encoded audio and metadata information on a conspicuous display. The data is displayed in frames with adjacent frames possessing some informational overlap either with both adjacent frames, or with only one adjacent frame. This redundancy makes splicing and re-ordering of audio information difficult, or when combined with the displayed metadata, impossible. The metadata displayed ordinarily has a signed hash to accommodate bandwidth constraints and comprises:

A randomized, never-duplicated serial code value for the device with a private and public key issued by the seller.

A similarly randomized registration code linking the device to the owner/primary user/registrant, so that on social media, cloud sites run by the SEDW company, private websites, corporate websites (e.g. Whitehouse.gov, etc.), the device is linked to an individual who has the power to post public keys and host or control higher-resolution media information hashed but not displayed by the SEDW device, in this case the TrueBadge.

A Session ID code to prevent collages from multiple speeches and track recordings.

Time-Date and time elapsed in the session stamps again to foil splicing and re-ordering.

Copies of the error-correcting codes broadcast to facilitate reading the TrueBadge or SEDW display, so a malicious actor cannot insert misleading or false error-correcting codes which do not match those signed.

Information on where to verify the data, such as a URL or app. While SEDW manufactures or individuals will make it known where or how to verify displayed information, this redundancy facilitates the identification of spoofing and could also be run by a program in the TrueBadge or SEDW and marked if it is the case that in fact the cloud location is the place particular data, such as a user profile, and the relevant public keys are stored.

If ordinary JABs are not used, customers can use templates for steganographic encryption or aesthetics, such as an animated flag or logo. The template ID transmitted at the beginning of a session verifies and describes information about the protocols used to encode data in the template. templates are identified by verifiers crudely or inputted into verifiers by registrants but must be signed and registered by an authoritative verifier for security and use specific data protocols to display data. This information gives data on how to read the data displayed either with a code or a link to a secure authenticated description of a template maintained by a trusted party such as the SEDWs cloud service, reliable third-party verifiers or even the SEDW registrant. A suspicious registrant with custom template flags suspicion, since it can be used as an SEDW spoofing strategy (since the template could define a codec), so just as device IDs and registrants should be connected to trusted verifiers, so must templates.

Free-text fields for the user or company or campaign.

Additionally, some non-encrypted information such as error-correcting codes, and template IDs along with text could be displayed such as a name, a campaign slogan, website etc.

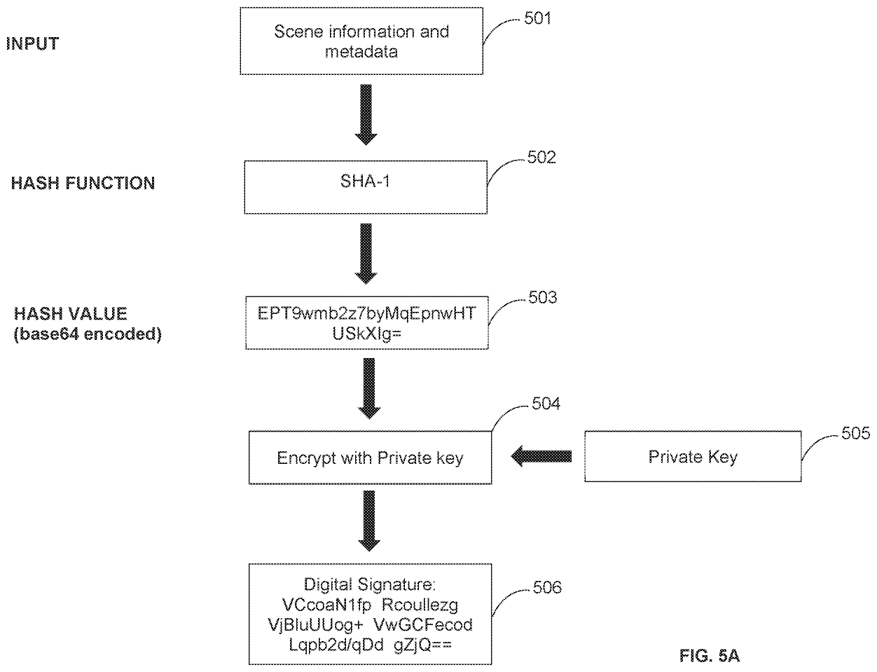

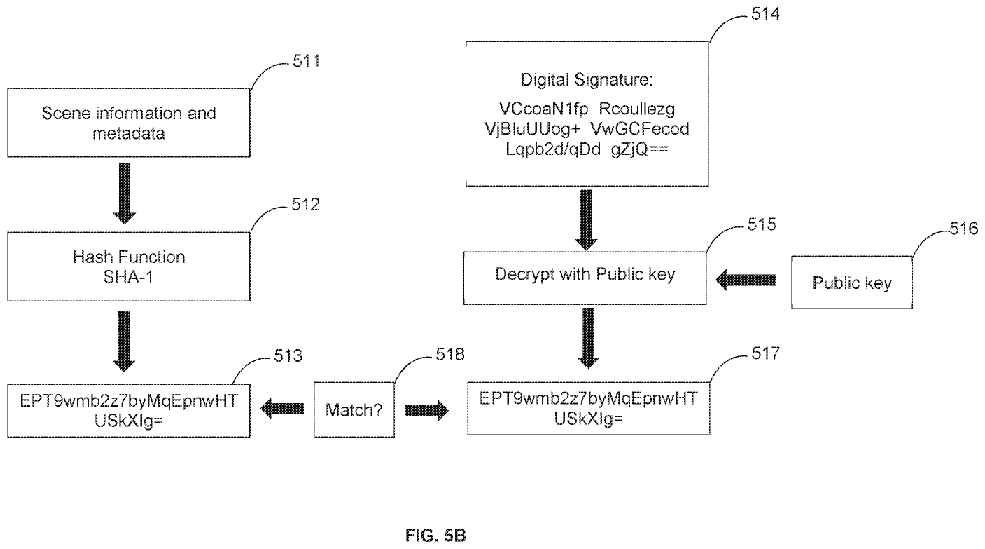

FIGS. 5A and 5B illustrate the central principles of digital signatures and what the verification would look like from a cloud data source. Referring first to FIG. 5A, at 501, scene information and metadata are input. At 502, the scene and metadata are hashed (say by SHA-1, SHA-256 or similar) to reduce the information. At 503 the hash value is encoded, and then at 504 the hashed output is signed by a private key 505 (or several private keys). At 506, the unsigned and unsigned data is displayed.

Verification of the audio in a video of the scene is shown in FIG. 5B. Like FIG. 5A, at 511 scene information and metadata are input, and at 512 are hashed. At 513, the hashed value is encoded. At 514 the digital signature is displayed (e.g., the digital signature 506 of FIG. 5A) and at 515 decrypted with public key 516. At 517, the decrypted data (i.e., the hashed information or audio) are compared to signed, or private key encryption of the hash which is decrypted with a public key. AT 518, if the two match, the hashed audio is displayed.

The particulars of how this is achieved are described above but include various critical innovations and several embodiments of dealing with media and meta-data hashing. For example, in one embodiment determined by the highly efficient audio codecs described, the TrueBadge displays both recorded audio information and a signed hash of metadata. Because the audio information is simultaneously displayed, and to prevent splicing the metadata, the successive audio data may optionally overlap with audio in the previous frames, and a simple program could render the audio data of the rebroadcast on the TrueBadge. Humans or AIs could then compare it with the audio in the suspect video.

Because of bandwidth limitations it is generally more practical to hash the audio and metadata and present a signed version of this data in the frames of the TrueBadge animation, and then verify the suspect video with signed data displayed on the badge. There are a variety of objectives ranging from interests in privacy, decentralization, extra-security, processing speed in verification provided by (i) presenting unsigned media hashes and signed meta-data hashes, (ii) unsigned unhashed audio (pure media) and signed meta-data hashes, (iii) signed unhashed audio and hashed signed meta-data, and (iv) unsigned or signed, hashed or unhashed media with unhashed signed meta-data.

Similarly, there may be interest in restricting certain kinds of data by withholding public keys to control which bits of media or meta-data are released. That is to say that the device would output different bits of data with different signatures. For example, if a user wanted to protect anonymity or GPS meta-data, they would selectively use different signatures and not publish the public keys required for verification for what they want to hide, but of course suffer in many cases an epistemic hit-since the differential signing would be detected by the verification process. Such a practice, which would benefit from the convenience of a feature, would be easiest if the user is able to change and/or re-register private key/public key pairs. This practice, however, reduces the epistemic utility of the device, and may be abused.

The SEDW is best understood as a generalization of the TrueBadge. The concept of display and record are simply generalized, and the form factor varied for the situation. The generalized concepts of display and record (sometimes used interchangeably with “broadcast”) does not alter the fundamental management of media, metadata, signatures, hashes or cloud storage of keys, profiles or higher-resolution media than can be practically broadcast.

Display generalized: The concept of “display” is generalized to include any kind of broadcast: any field change, energy radiation, or even produced morphological changes (such as moving an analog dial hand or rhythmically inflating and deflating or firing projectiles) to rebroadcast facts about the scene to a device that is recording the scene and the conspicuous output of the SEDW device. The SEDW broadcast may arise from peripherals such as IOT lamps, smart speakers, phones, special purpose devices etc.

Broadcasts generally come in two forms, salient or hidden, but are always meant to be conspicuous in the sense that a SEDW device's broadcasts are such that a recording device will pick-up the broadcast. Among the hidden broadcasts are subtle signal carrying broadcasts that SEDW devices may use as sound overlays, and which use psychophysical masking (so humans are not bothered by it but recording devices will pick-up the sound). Also included are ultra and infra sound and light, high-frequency light pulsing, steganography broadcast on screens in the house, vibrations such as of windows or furniture or decorative objects. Among the non-hidden broadcasts are lasers (moving, oscillating, or changing color or amplitude), screen displays, visible light, audible sound, braille like-dots oscillating, LEDs on clothing, additional lights on cars etc. Furthermore, broadcasts can include radio designed to be picked-up by the ubiquitous radio sensors which may be used to record data in scenes such as WI-FI®, BLUETOOTH®, or other frequencies. Radio has the secondary advantage as do some forms of light and sound to communicate to peripherals and apps designed to work with or be components of multi-component SEDWs. Finally, simply wired signal outputs work as well, to for example plug into the amplification system of a political rally or music concert.

Media: The TrueBadge typically records audio, but the generalize SEDW device may be designed to record any kind of scene information or set of scene information in the broadest sense. For example, an SEDW device may record basic radioactive and mechanical energy, and fluxes, such as light, sound, mechanical vibration, and location data. The SEDW device may also record slowly or rapidly changing mechanical and scene information. Thus air-pressure, humidity, chemical signatures, gravity, UV radiation, pollution, and data produced from movement, such as wind, accelerometer data, air-pressure, seismic data, vibration, mechanical energy, location data such as local radio and heat emissions, sonar monitoring of the space, street signs, light polarization etc. may also be recorded. Further, recondite but useful scene information may be recorded, such as muons or radioactive particles detected by Geiger counters, chemo-tactic information such as sweat, blood and tear spectroscopy, gait information, moisture (e.g., wet pipes monitored by sensory RFIDs), heartrates, blood pressure, EEG or other brain imaging recording etc.

Form factors: Critically SEDWs do not have to conform to the TrueBadge form factor, and some particularly important form factors are discussed. They will usually be apps for mobile devices produced by the SEDW maker but may also be stand-alone devices. Generally, variations run large, small, or modular. Large, for example, a sign. Small, so it can be placed in convenient locations, for example, a watch screen having a camera, and modular in cases where it is necessary to spatially separate components such as sensors, displays, a computer, modules, or onboard storage.

Remote inspection applications: Building construction is onerous and requires that inspectors come out to the location of a project at different stages of construction, and if inspectors are not on-time, work is delayed. Other inspections (e.g., inspection of meat production or other food production facilities) may be facilitated if the bureaucratic agency could trust electronic recordings provided by those persons being inspected. Recordings do not have to be limited to audio, camera stills, or even two-dimensional light profiles, but can include chemo-detection, density assessed by sonar, solid state x-ray imaging, sonar measurements (e.g., to satisfy accessibility requirements), electrical current recordings, distribution of metal meshes, pipe locations, etc. Described below is a SEDW device authenticated inspection that may obviate the need for a municipal or liability inspector (e.g., an insurance agency inspector).

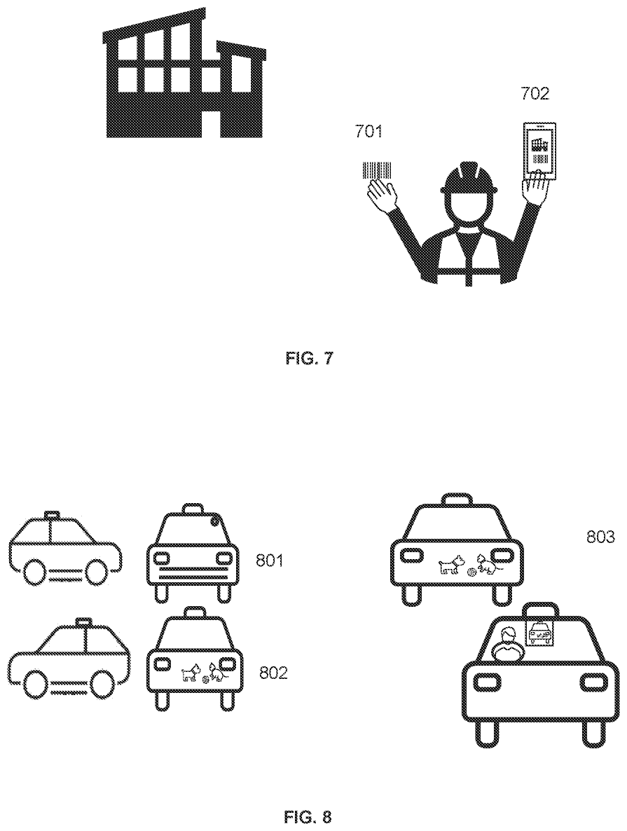

Referring to FIG. 7, imagery is obtained with an ordinary camera capturing both the item the inspector wants to examine 701 and a phone 702 running a SEDW app displaying a barcode with a signed hash that can be used to verify what is photographed by the ordinary camera. In other words, a photo is taken of the scene and a person holding a SEDW device also filming the scene and displaying a signed encoding.

In more complex cases, more advanced SEDW devices or peripherals need to be used. Lidar and sonar capabilities are already within the powers of high-end phones and tablets instantiated as SEDW devices because they are running authentic SEDW apps.

Vehicular SEDW devices: SEDW devices may be deployed on cars. In much of the world, traffic accidents are contested and services will maliciously modify dashcam footage. Vehicular SEDW devices are designed to be as conspicuous as possible without interfering with safety or aesthetics and can have displays broadcasting both hidden and salient signals from all sides of the vehicle. The SEDWs may be added as secondary lightbulb-like kits under existing head and/or rear lamps, amended with LED strips, and use sound and/or other high-resolution data.

For example, and referring to FIG. 8, taillights 801 may be equipped with infrared lighting and a portion of the back of the car may be an LED screen display 802. An individual bar code may be assigned to each driver, and when scanned, SEDW displays may be generated on the back of the car utilizing the infrared lighting of taillights 801 and the LED screen display 802. Additional SEDW displays (e.g., display 803) may also be located on the front of the car. Such SDEW display may be utilized to foil fake dashcam footage.

Critical data relevant for car accidents may be recorded from the SEDW device (as app or standalone) and can include a subset, depending on the resolution desired, of video, sound, accelerometer data, directional data, location data, sonar or radar (for both location of obstacles and absolute speed if elsewhere unavailable). Also, vehicular SEDWs can monitor the interior of the car via specially made dual-dash cams. An internal dashcam may record hidden audio signals or simply be part of the screen of a phone audio-video recording the insides of the vehicle. A well-placed mirror or light splitter may be attached to the dashcam's internal display if necessary. But, an overlaying hidden audio signal of a signed hash to the dual dashcam is the most convenient instantiation given the current marketplace of dual dashcams. This again, requires nothing but an app feature from the SEDW maker.

Location verification: In the world of INSTAGRAM® faking locations is tempting. Verifiable SEDW devices may be placed in or on, for example, a fine dining establishment or a road sign to verify a person's location.

A camera component of the SEDW may point at tourists or visitors, and a background including a distal display, may present a signed hash of the image showing the actual tourists along with the scene. Users or owners of SEDWs may show their phone in a photo which records and rebroadcasts, as an ordinary screen display, the location. Heavily desirable sites, such as a photo at the top of Mount Kilimanjaro may motivate the deployment of specialized location verification devices.

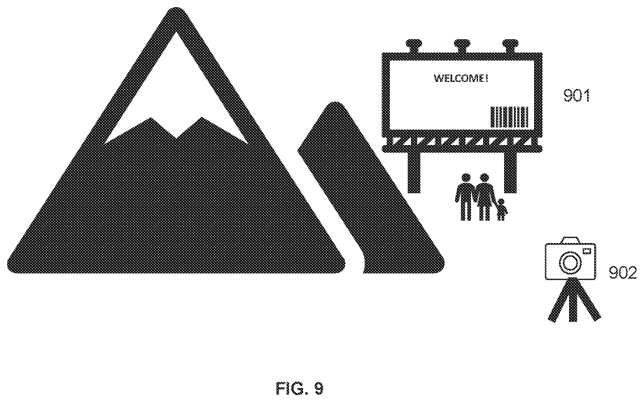

Referring now to FIG. 9, a screen display 901 may contain barcodes for visiting travelers to scan to determine greetings, information, and announcements for a specific location. In addition, a photo taken by a camera 902 at the visited site, verifies the identities of visitors. Such information regarding the identities of visitors may be stored in the cloud.

A further non-obvious way to display the veridical location is for the location to use a camera which projects a safe but visible laser projecting an image with the signed hash on the tourists, for example a thigh. Such method may also be deployed to project an image with a signed hash, for example, on the lips of a person making a public speech. This obviates the need for a separate display board. Generally, the more compact the SEDW device the more secure the device will be to hacking. Attempts to hack or break the device can issue an error code in the metadata.

Anti-exploitative deepfake applications combining SEDWs with life-logging: Of much concern because it is both salacious and allegedly impossible to solve are the malicious creations of pornographic or reputationally damaging (to human or non-human entities) synthetic media designed to disinform. In the pornographic case, a video usually of a woman, is synthesized showing her likeness engaged in sexual acts which did not occur. Even given the anti-deepfake SEDWs described, another component must be added, specifically life logging.

Since an instance of a non-embarrassing event, even authenticated by an SEDW device, does not rule out reputation damaging antics generated from whole cloth—not mere modification, but entire fabricated deep-fakes—one must use additional protection. One could always wear their TrueBadge, SEDW wearable device, or rely on the future ubiquity of SEDW devices. However, a secondary, complementary defensive embodiment may be used, namely, passive complementary lifelogging to be combined/integrated with SEDW devices. Protection I achieved in two steps, a life-logging step and utilization of an SEDW device are used in tandem.

In the lifelogging step a person can use a feature of SEDW apps or devices or their own systems to track their location and/or activity. Individuals would in nearly all cases want this information private until it is needed and should use the regular state-of-the art cyber security methods to store the data, or signed hashes thereof when feasible, along with verification that the life-logging data is veridical.

For example, something as crude as typing in or having a phone record an individual's location without an additional security measure would fail, because if challenged, the log may not be believable. Also, such active logging would be onerous. The critical additional security measure ties the log to the individual. Such technologies are already partially or entirely employed in iOS locking mechanisms.

Wearable or implanted unlocking: iOS 15 and even previous versions can lock when a time period expires, just as computers have locked automatically for years when there is a lack of activity during a pre-set time period. However, if an individual is wearing an APPLE WATCH® (or competing wearable) communicating with the computer or phone, and the wearable has a code or biometric lock and detects removal, the wearable will unlock the phone or computer when the user goes to use these devices, thus sparing the user from re-entering a password or posing or activating a biometric scan.

Additionally, one may also passively lifelog their time and location and depending on the defensive capabilities required, a subset of ambient scene sounds, heart-rate, movement, temperature, light levels or other scene data taken from the watch or a device that can be electronically assured to be near the individual. Then, so far as the device is concerned, use wearable locking technology to link their lifelog to their phone and identity via their phone as a proxy.

Should standards not accept the current device wearing protocols as a proxy for linking an individual to a log (since they only link an individual to a phone), the DeepAuthentic app or third parties can amend wearables to include biometric identification. This can be done with identifying biometrics on the watch ranging from cameras to fingerprint scanners to other unique biometrics such as heartbeat waveforms combined with electrical waveform and conduction time of a heart contraction signal, or image captures of the individual wearing the watch displaying a signed barcode, or by playing a sound or broadcasting a signal identifying to the SEDW app that the watch is in fact being worn by the correct individual. The DeepAuthentic app may further monitor to require new data if necessary.

Home, office or near ubiquitous personal SEDW devices that are always on and broadcasting would alleviate this poxy hassle.

SEDW device step: With life-logged, the vulnerable can protect themselves in bedrooms and public with SEDW devices, such as a phone or IOT lamp broadcasting non-distracting hidden scene information.

Lifelogging SEDW devices: A further invention claimed is an integrated life logger-SEDW device as described above. That is a watch, a TrueBadge-like device that performs both lifelogging and the recording and broadcasting of a SEDW device.

SEDW device textiles: To protect individuals from authorities with a history of unreliable badge cameras or unjust accusations, sweatshirts integrated with LEDS or other aesthetically pleasing broadcaster displays can project the location history, heart rate, sounds, accelerometer data, video and even the presence of weapons through built in metal detectors. The information displayed can be contemporaneous or a hash history of multiple hours. The aim is to provide evidence stored in the cloud and broadcast on the body of all individuals, especially those who are victims of police violence.

For portable SEDWs or those with laser displays, delivery companies may use them to verify that packages are dropped off at specific locations.

SEDWs may be further integrated with intelligent sensors executing smart contracts. To verify that work has been done or a commodity fairly split and to prohibit various kinds of cheating, an SEDW may be used to display its data imprimatur onto the scene via laser, a scanning SEDW device, or app with a continuous display, so that all sensors sending data to the automated contract get veridical information, and attempts to trick the smart contract sensors with fake feeds or fake displays placed in front of sensors (such as a camera) are foiled.

The previous description of the disclosed embodiments is provided to enable any person skilled in the art to make or use the embodiments disclosed. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A display badge comprising:
an audio detection component, the component detecting at least a portion of ambient audio data of an actual event;
a computing device operably connected to a recording component, the computing device converting at least a portion of the detected ambient audio data into a digital representation of the at least a portion of the ambient audio data;
a display presenting a succession of images comprising the digital representation;
where the display badge is designed such that the digital representation is sufficiently visible that it may be extracted by a computer upon replay of audio and video of some or all of the actual event, and the replay audio may be verified as authentic by comparing the digital representation with the audio associated with the replay.

2. The display badge of claim 1, where at least one of the succession of images includes metadata.

3. The display badge of claim 2, where the metadata is signed.

4. The display badge of claim 2, where the metadata includes a unique serial code for the display badge.

5. The display badge of claim 2, where the metadata includes a randomized registration code linking the display badge to a registered owner.

6. The display badge of claim 2, where the metadata includes a session ID code.

7. The display badge of claim 2, where the metadata includes a date or time of the actual event.

8. The display badge of claim 2, where the metadata includes an elapsed time of the actual event.

9. The display badge of claim 1, where the digital representation comprises a fingerprint of some or all of the audio data.

10. The display badge of claim 1, where the succession of images further contain at least one digital signature.

11. The display badge of claim 1, where the digital representation is hidden within one or more images utilizing steganography.

12. The display badge of claim 1, where the digital representation is presented in a specific portion or portions of the visual spectrum.

13. The display badge of claim 12, where the specific portion or portions of the visual spectrum include at least visual data transmitted in wavelengths outside of the range of human visual acuity, less than approximately 380 nanometers or greater than approximately 750 nanometers.

14. The display badge of claim 1, where the digital representation contains at least some recorded audio.

15. A method for encoding media data in a display badge, the method comprising:
detecting, by an audio detection component operably connected to the display badge, at least a portion of ambient audio data of an event;
encoding as all or part of one or more images, one or more digital representations of the at least a portion of the ambient audio data;
hashing the at least a portion of the one or more digital representations;
signing hashed data with a private key; and
displaying the one or more images and the signature on the display badge.

16. The method of claim 15, further comprising signing each of the one or more digital representations.

17. The method of claim 15, where the hashing method is fingerprinting.

18. The method of claim 15, where the display badge is a mobile communications device.

19. The method of claim 15, where the display badge is operably coupled to a mobile communications device.

20. A method for authenticating media data, the method comprising:
capturing media data to be authenticated, where the media data includes video of a display badge containing an encoded first hash of one or more recorded portions of audio data of an actual event;
identifying the encoded first hash;
creating a second hash of some or all of the audio portion of the media data;
comparing the first and second hashes; and
determining, based on the comparing, whether the audio has been manipulated or altered between a generation of the first hash and a generation of the second hash.

21. The method of claim 20, where the first hash includes a digital signature generated using one or more private keys, and the method further comprises applying one or more public keys to verify the digital signature.

22. The method of claim 20, further comprising requiring authentication of a user prior to initiation of authentication of the media data.

23. The method of claim 20, where the hashing method is fingerprinting.
